(19) United States
(12) Patent Application Publication
(10) Pub. No.: US 2023/0125348 A1
(43) Pub. Date: Apr. 27, 2023

(54) DYNAMICALLY MODIFIABLE AIR MOVERS AND CONTROL THEREOF

(71) Applicants: Shantanu D. Kulkarni, Hillsboro, OR (US); Ruander Cardenas, Portland, OR (US); Jeff Ku, Taipei City (TW); Mark A. MacDonald, Hillsboro, OR (US); Samarth Alva, Bangalore (IN); Vipin Ghanshamrao Bokade, Bangalore (IN); Srinivasarao Konakalla, Bangalore (IN); Arnab Sen, Whitefield (IN)

(72) Inventors: Shantanu D. Kulkarni, Hillsboro, OR (US); Ruander Cardenas, Portland, OR (US); Jeff Ku, Taipei City (TW); Mark A. MacDonald, Hillsboro, OR (US); Samarth Alva, Bangalore (IN); Vipin Ghanshamrao Bokade, Bangalore (IN); Srinivasarao Konakalla, Bangalore (IN); Arnab Sen, Whitefield (IN)

(21) Appl. No.: 18/066,271

(22) Filed: Dec. 14, 2022

(51) Int. Cl. F04D 29/40; F03G 7/06; F04D 29/02

(52) U.S. Cl. CPC F04D 29/403; F03G 7/06143; F04D 29/02; G06F 1/203

(57) ABSTRACT

Dynamically modifiable air movers can be modified during operation of a computing system to allow the performance of the fan (air flow, air flow split between exhausts) to be adjusted based on a workload being performed by the system. The physical modifications that an air mover can undergo are physical in nature and include adjusting the placement of one or more cutwaters, expanding or contracting an expandable portion of the fan housing, covering or uncovering an exhaust to provide or remove cooling to memory components, and moving a slidable strip to extend or withdraw from an exhaust. Causing one or more of these physical modifications to be made can be performed in response to the system determining that a temperature, rate of temperature change, power consumption level, rate of power consumption level change of the system or system components exceeds or has dropped below a threshold level.

### BACKGROUND

In existing laptops, the design of an air mover can be tuned for one workload scenario, which may render its performance less than optimal for other workload scenarios. For example, an air mover that is tuned for quiet performance may limit a laptop's capacity to provide sufficient cooling when executing high-performance workloads.

### BRIEF DESCRIPTION OF THE DRAWINGS

FIG. 1 is a simplified illustration of the physical architecture of an example laptop base utilizing dual outlet fans.

FIGS. 2A-2B illustrate cross-sectional views of a first example dynamically modifiable air mover.

FIGS. 3A-3B illustrate cross-sectional views of a second example dynamically modifiable air mover.

FIGS. 4A-4B illustrate cross-sectional views of a third example dynamically modifiable air mover.

FIGS. 5A-5D illustrate cross-sectional views of a fourth example dynamically modifiable air mover.

FIGS. 6A-6D illustrate cross-sectional views of a fifth example dynamically modifiable air mover.

FIG. 7 is a graph showing the air flow versus sound pressure level curve for an example single outlet dynamically modifiable air mover.

FIG. 8 is a graph showing the air flow split versus sound pressure level curve for an example dual outlet dynamically modifiable air mover.

FIG. 9 is a block diagram of an example computing system comprising a dynamically modifiable air mover.

FIG. 10 is an example method of dynamically modifying an air mover in a computing system.

FIG. 11 is a block diagram of an example computing system in which technologies described herein may be implemented.

FIG. 12 is a block diagram of an example processor unit to execute computer-executable instructions as part of implementing technologies described herein.

### DETAILED DESCRIPTION

To cater to end users' needs, some existing laptops have multiple usage modes that each provide a particular experience. For example, some existing laptops have a performance mode and a quiet mode. These modes can have different cooling needs, but the physical design of the air movers used in these systems is fixed. As a result, performance of these air movers over a range of speeds is fixed as well. This presents certain design challenges and can result in non-optimal fan performance in some modes of operation. For example, a single outlet fan tuned for a quiet mode of operation, in which the fan operates at lower speeds (and thus lower air flow rates) so that fan noise is kept down, may provide lesser air flow rates (and thus result in higher skin or junction temperatures) when the system is operating in a high-performance mode relative to a fan tuned for a high-performance mode of operation. Similarly, a fan tuned for a high-performance mode may be noisier when the system is performing in its quiet mode than a fan turned for quiet mode performance. A system with a fan tuned to provide adequate cooling for high-performance workloads may also be thicker than a system with a fan tuned for a quiet mode as a thicker fan may be needed to provide a desired level of air flow.

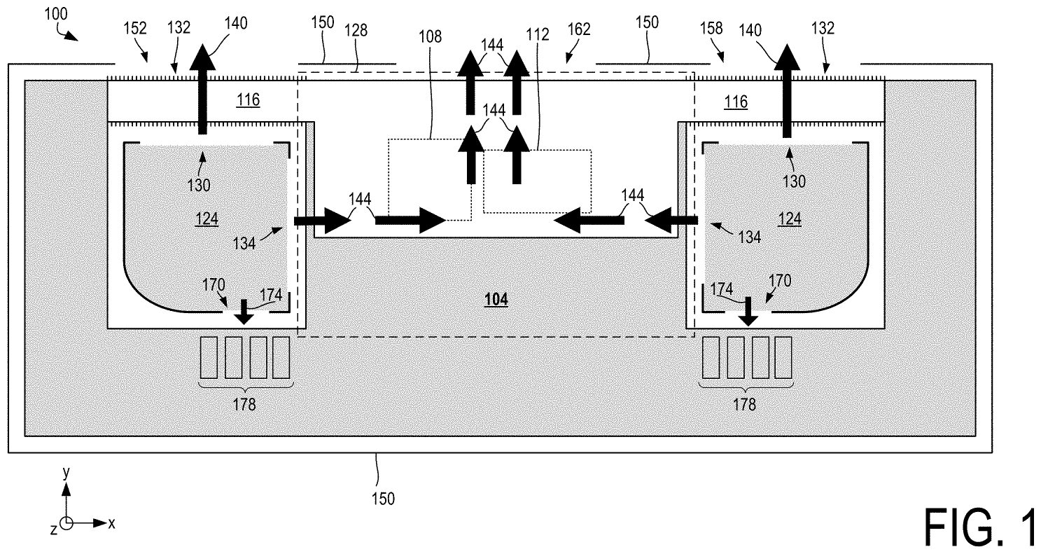

Similar challenges can be present in laptops that use dual outlet fans. FIG. 1 is a simplified illustration of the physical architecture of an example laptop base utilizing dual outlet fans. The base 100 comprises a central processor unit (CPU) 108, a graphics processor unit (GPU) 112, and a printed circuit board 104 upon which the CPU 108 and GPU 112 are attached. The CPU 108 and GPU 112 are located within a core region 128 of the printed circuit board 104. The thermal management solution used in the base 100 to cool the CPU 108 and the GPU 112 comprises a heat transfer device 116 located on the CPU 108 and the GPU 112 and attached to fins 132 (or another heat exchanger) located on either side of the core region 128. The heat transfer device 116 cools the CPU 108 and GPU 112 by transferring heat generated by the CPU 108 and GPU 112 to the fins 132.

The thermal management solution for the base 100 further comprises two dual outlet fans 124. The fans 124 comprise first exhausts 130 and second exhausts 134 Air exiting the fans 124 from the first exhausts 130 flows over or through the fins 132 and left system exhaust 154 and right system exhaust 158, as indicated by arrows 140. The left and right system exhausts 154 and 158 are defined by the housing 150 of the base 100. As heat generated by the CPU 108 and the GPU 112 is transported to the fins 132 by the heat transfer device 116, the junction temperature of the CPU 108 and the GPU 112 can depend primarily upon the amount of air exiting the first exhausts 130, passing over or through the fins 132, and out the left and right system exhausts 154 and 158. Air exiting from the second exhausts 134 flows through the core region 128 of the printed circuit board 104 and out a center system exhaust 162 defined by the housing 150, as indicated by arrows 144. The skin temperature of the base 100 in the vicinity of the core region 128 can depend primarily on the amount of air exiting the second exhausts 134 of the fans 124, flowing through the core region 128, and out the center system exhaust 162. The laptop base design illustrated in FIG. 1 thus uses the fans 124 in a semi-hyperbaric fashion. The air exiting the first exhausts 130 and passing through the fins 132 provides evacuating cooling and the air exiting the second exhausts 134 provides hyperbaric cooling to the core region 128 of the printed circuit board 104 by increasing the air pressure in the core region 128 to force air through the core region 128 and out of the base 100 through the center system exhaust 162.

The heat transfer device 116 can be a vapor chamber, cold plate, heat pipe, or another suitable device for transferring heat. A cold plate can be any suitable type of cold plate, such as a tubed cold plate or a cold plate comprising internal fins or channels (e.g., microchannels), and be made of any suitable material, such as copper, aluminum, or stainless steel that is chemically compatible with immersion and working fluids.

For some existing laptop base designs such as illustrated in FIG. 1, the air flow split between the first exhausts 130 and the second exhausts 134 is set once the fans 124 are installed. The air flow split can be determined by the design of the fans 124 and the impedance of air flow through the base 100. But, different operating points of the laptop may need different air flow split requirements. For example, tuning the air flow split such that the air flow existing the first exhausts 130 of the fans 124 keeps the junction temperatures of the CPU 108 and the GPU 112 below a desired level for a desired level of power consumption in a high-performance mode of the laptop may result in the air flow exiting the second exhausts 134 of the fans 124 to be less than needed to keep the skin temperature of the base 100 below a desired temperature. Similarly, tuning the air flow split such that the air flow through the second exhausts 134 is sufficient to keep the skin temperature of the laptop base below a desired temperature may result in the air flow through the first exhausts 130 being insufficient to allow the system to operate at a desired high-performance level while staying within thermal (junction temperature) limits.

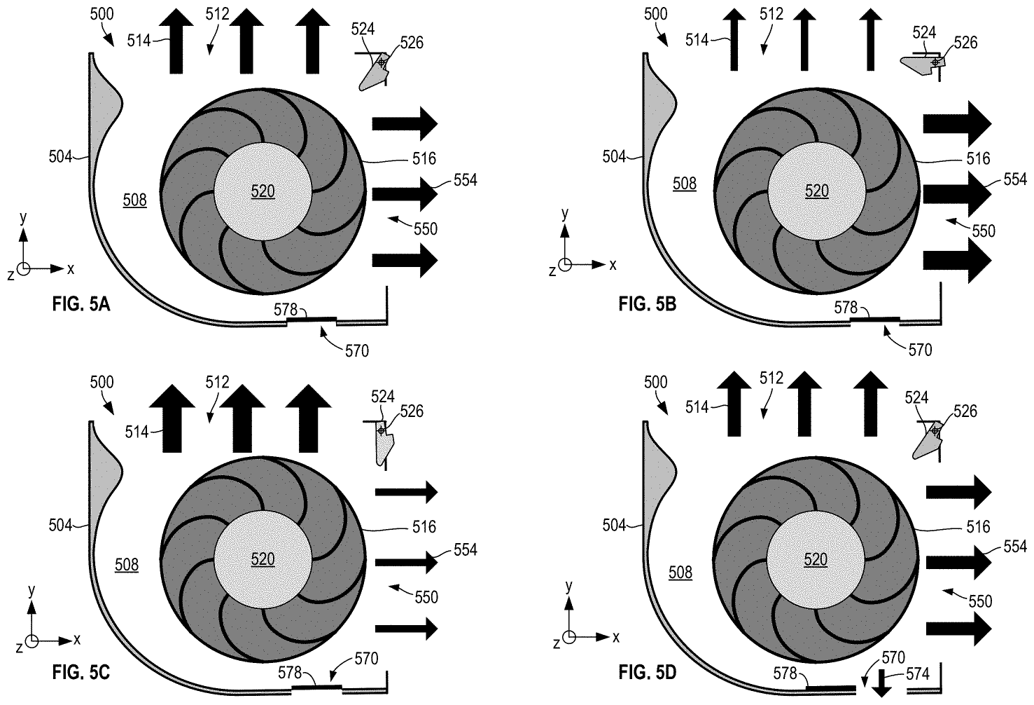

In some embodiments, the fans 124 can be any of the dynamically modifiable air movers disclosed herein, and the fans 124 can have optional third exhausts 170 that can provide cooling to memory integrated circuit components 178 located on the printed circuit board 104 but not cooled by the heat transfer device 116, as will be discussed further in reference to FIGS. 5A-5D.

Disclosed herein are dynamically modifiable air blowers and methods of controlling the same. The physical configuration of air movers, and thus their performance, can be modified during operation of a computing system within which the air movers are located to achieve a desired level of air flow, acoustic level, and/or air flow split between exhausts (in dual outlet air movers), depending on system workload. That is, the disclosed air movers can dynamically change their performance curves and operating flow points based on workload needs. The air movers can be physically modified on the fly by changing cutwater placement to alter the distribution of air flow within the air mover, physically expanding the size of an exhaust to increase the amount of air exiting the exhaust, sliding a movable strip to extend into an exhaust to alter the amount of air exiting the exhaust, and/or moving an exhaust cover to cover or uncover an exhaust. Various actuators can be used to cause the physical modifications to be made to the air movers, such as stepper motors, rack-and-pinion actuators, and shape memory alloy-based actuators. Passive spring-based mechanisms can also provide dynamic modification of the disclosed air movers. The air movers can be dynamically modified based on the type of workload being performed by the system, which can be determined based on telemetry data indicating a temperature or power consumption of one or more integrated circuit components and/or of the computing system.

The dynamically modified air movers and associated control methods have at least the following advantages. First, the rate of air flow exiting an air mover exhaust, the air flow split across exhausts in multi-outlet air movers, and the acoustic level of air movers can be changed based on the workload being executed by the computing system. This can allow for a system to achieve air flow rates, air flow splits, and/or acoustic levels that are tuned for multiple operational modes of the system. Second, by being able to dynamically modify the amount of air flow exiting an exhaust dynamically, thinner air movers can be utilized for a particular design, which can result in reduced overall system height.

In the following description, specific details are set forth, but embodiments of the technologies described herein may be practiced without these specific details. Well-known circuits, structures, and techniques have not been shown in detail to avoid obscuring an understanding of this description. Phrases such as “an embodiment,” “various embodiments,” “some embodiments,” and the like may include features, structures, or characteristics, but not every embodiment necessarily includes the particular features, structures, or characteristics.

Some embodiments may have some, all, or none of the features described for other embodiments. “First,” “second,” “third,” and the like describe a common object and indicate different instances of like objects being referred to. Such adjectives do not imply objects so described must be in a given sequence, either temporally or spatially, in ranking, or in any other manner. “Connected” may indicate elements are in direct physical or electrical contact with each other and “coupled” may indicate elements co-operate or interact with each other, but they may or may not be in direct physical or electrical contact. Furthermore, the terms “comprising,” “including,” “having,” and the like, as used with respect to embodiments of the present disclosure, are synonymous. Terms modified by the word “substantially” include arrangements, orientations, spacings, or positions that vary slightly from the meaning of the unmodified term. For example, a first wall that is substantially orthogonal to a second wall includes first and second walls that have an angle within several degrees of 90 degrees between them.

In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives within the scope of the claims

As used herein, the phrase “located on” in the context of a first layer or component located on a second layer or component refers to the first layer or component being directly physically attached to the second part or component (no layers or components between the first and second layers or components) or physically attached to the second layer or component with one or more intervening layers or components. For example, with reference to FIG. 1, the heat transfer device is located on the CPU 108 and GPU 112 (with an intervening thermal interface material (TIM) layer).

As used herein, the term “integrated circuit component” refers to a packaged or unpacked integrated circuit product. A packaged integrated circuit component comprises one or more integrated circuit dies mounted on a package substrate with the integrated circuit dies and package substrate encapsulated in a casing material, such as a metal, plastic, glass, or ceramic. In one example, a packaged integrated circuit component contains one or more processor units mounted on a substrate with an exterior surface of the substrate comprising a solder ball grid array (BGA). In one example of an unpackaged integrated circuit component, a single monolithic integrated circuit die comprises solder bumps attached to contacts on the die. The solder bumps allow the die to be directly attached to a printed circuit board. An integrated circuit component can comprise one or more of any computing system component described or referenced herein or any other computing system component, such as a processor unit (e.g., system-on-a-chip (SoC), processor core, graphics processor unit (GPU), accelerator, chipset processor), I/O controller, memory, or network interface controller.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform or resource, even though the software or firmware instructions are not actively being executed by the system, device, platform, or resource.

Reference is now made to the drawings, which are not necessarily drawn to scale, wherein similar or same numbers may be used to designate same or similar parts in different figures. The use of similar or same numbers in different figures does not mean all figures including similar or same numbers constitute a single or same embodiment. Like numerals having different letter suffixes may represent different instances of similar components. The drawings illustrate generally, by way of example, but not by way of limitation, various embodiments discussed in the present document.

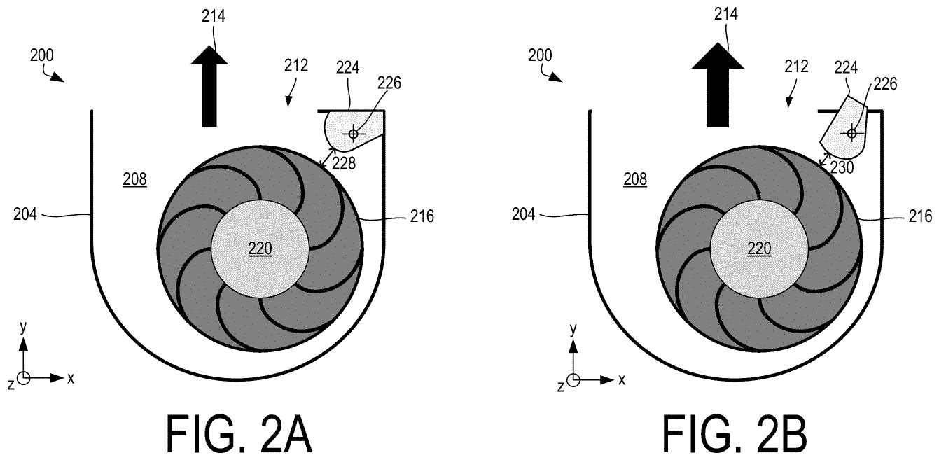

FIGS. 2A-2B illustrate cross-sectional views of a first example dynamically modifiable air mover. The air mover (or fan) 200 is a single outlet fan comprising a housing 204 that defines an internal volume 208 and an exhaust 212. An impeller 216 located within the internal volume 208 rotates clockwise about a hub 220 during operation of the fan 200, drawing air into the impeller 216 through one or more inlets (not shown) and out the exhaust 212, as indicated by arrows 214. The impeller 216 and the hub 220 are not centered within the internal volume (volute) 208. The distance between the impeller 216 and the housing 204 generally increases as one moves clockwise from a point on the impeller closest to a cutwater 224 toward the exhaust 212.

A movable cutwater 224 divides the flow of air within the internal volume 208 between the exhaust 212 and a region of the internal volume 208 between the cutwater 224 and the impeller 216. The cutwater 224 is rotatable about an axis 226 and can thus be in various placements as it rotates. The cutwater 224 is a cam wherein a minimum distance between the cutwater 224 and the impeller 216 is a distance 228 that can vary as the cutwater 224 rotates about the axis 226. FIGS. 2A and 2B illustrate the cutwater 224 in first and second placements, respectively, the cutwater 224 rotating about the axis 226 to move the cutwater 224 from the first placement to the second placement. The minimum distance between the cutwater 224 and the impeller 216 is a distance 228 in FIG. 2A and a distance 230 in FIG. 2B, the second distance 230 being less than the first distance 228. Thus, moving the cutwater from one placement to another can alter the air flow dynamics of the fan 200 by changing aerodynamic forces inside the fan.

The first cutwater placement can be a default placement that the cutwater 224 is in when the system in which the fan 200 is located is operating under normal conditions and the second cutwater placement can be a placement the cutwater 224 is moved to when the system is executing a high-performance workload or operating in a high-performance mode. As the second distance 230 is less than the first distance 228, the amount of air flowing through the exhaust 212 is greater during operation of the fan 200 when the cutwater 224 is in the second placement due to the cutwater 224 blocking more of the internal volume 208. The cutwater 224 can be moved from a first, default placement to a second placement where the cutwater is moved to a maximum extent in a single step or gradually. That is, in some embodiments, the cutwater 224 can be moved to placements between the first and second placements indicated in FIGS. 2A and 2B.

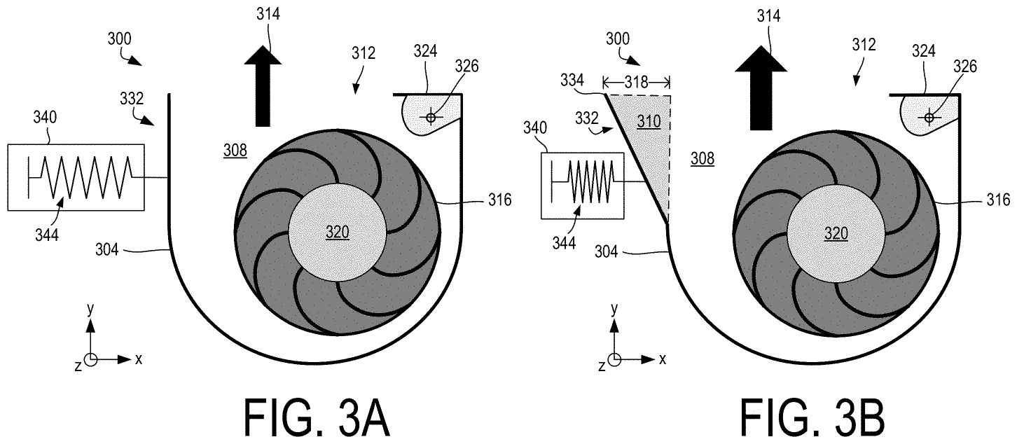

FIGS. 3A-3B illustrate cross-sectional views of a second example dynamically modifiable air mover. The air mover 300 is similar to air mover 200, but with a housing that has an expandable portion that can increase the size of the internal volume and the exhaust. The air mover 300 comprises a housing 304 that defines an internal volume 308 and an exhaust 312. An impeller 316 located within the internal volume 308 rotates clockwise about a hub 320 during operation of the fan 300, drawing air into the impeller 316 through one or more inlets (not shown) and out the exhaust 312. The impeller 316 and the hub 320 are not centered within the internal volume 308 and are offset toward a movable cutwater 324.

The movable cutwater 324 divides the flow of air within the internal volume 308 between the exhaust 312 and a region of the internal volume 308 between the cutwater 324 and the impeller 316. The cutwater 324 is rotatable about an axis 326 and can thus be in various placements as it rotates. The cutwater 324 is a cam wherein a minimum distance between the cutwater 324 and the impeller can vary as the cutwater rotates about the axis 326, thereby altering the air flow between the exhaust 314 and the region of the internal volume 308 between the cutwater 324 and the impeller 316.

The housing 304 comprises a portion 332 that can be expanded (deflected, or otherwise manipulated) to alter the size of the internal volume 308 and the exhaust 312. The portion 332 can comprise flexible, stretchable, and/or expandable material in the top and bottom sides of the fan 300. The housing wall connecting the top and bottom sides of the fan in the portion 332 can also comprise flexible, stretchable, and/or expandable material. In some embodiments, the portion of the housing wall in the portion 332 can be rigid. FIG. 3A illustrates the portion 332 in a first placement wherein the portion 332 is not expanded. FIG. 3B illustrates the portion 332 in a second placement in which the portion 332 is expanded to increase the internal volume 308 of the fan 300 by a volume 310. The size of exhaust 312 is increased as well (the width of the exhaust 312 is increased by an amount 318), although the increase in the width of the exhaust 312 can be less than the amount 318 in embodiments where the opening of the exhaust 312 does not extend all of the way to an end 334 of a wall of the housing 304). In some embodiments, the portion 332 can be placed in more than a non-expanded placement and an expanded placement. For example, in some embodiments, the portion 332 can be placed in one of a plurality of expanded placements.

An actuator 340 causes the portion 332 to expand (move the portion 332 from the first placement illustrated in FIG. 3A to the second placement illustrated in FIG. 3B) or contract (move the portion 332 from the second placement illustrated in FIG. 3B to the first placement illustrated in FIG. 3A). The actuator 340 can comprise one or more shape memory alloy wires 344 that contract when heated (such as by Joule heating), the contraction of the SMA wires causing the portion 332 to be expanded. Cooling of the SMA wires can cause the portion 332 to contract. In other embodiments, the actuator 340 can comprise another suitable actuator that causes the portion 332 to move.

The portion 332 can be moved to increase the size of the internal volume 308 of the fan 300 when the system in which the fan 300 is located is operating a high-performance workload or operating in another mode or under conditions where increased fan cooling would be beneficial. The fan 300 is shown with a movable cutwater 324 in addition to the movable portion 332. The cutwater 324 and the portion 332 can be moved simultaneously to increase the amount of air exiting the exhaust 312. Alternatively, the cutwater 324 or the portion 332 can be moved independently to increase the amount of air exiting the exhaust 312. In embodiments where the cutwater 324 and the portion 332 can be placed in multiple placements that cause an increase in the exhaust air flow, both the cutwater 324 and the portion 332 can be moved to increase the exhaust air flow, but they can be moved by different amounts such that either the cutwater 324 or the portion 332 is predominantly responsible for an increase in exhaust air flow.

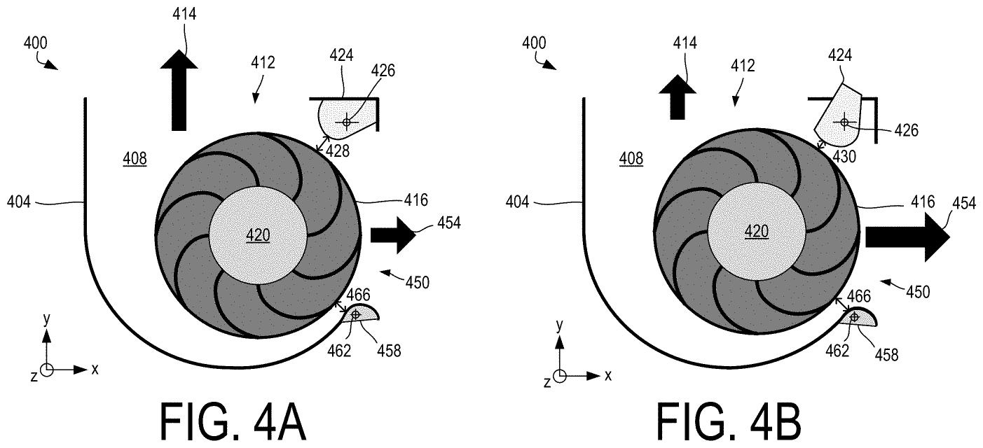

FIGS. 4A-4B illustrate cross-sectional views of a third example dynamically modifiable air mover. The fan 400 is similar to the fan 200 illustrated in FIGS. 2A-2B but with a second exhaust and second movable cutwater. The fan 400 comprises a housing 404 that defines an internal volume 408, a first exhaust 412, and a second exhaust 450. An impeller 416 rotates clockwise about a hub 420 during operation of the fan 400, drawing air into the impeller 416 through one or more inlets (not shown) and out the first and second exhausts 412 and 450, as indicated by arrows 414 and 454, respectively. The impeller 416 and the 420 are not centered within the internal volume 408 and are offset toward a first movable cutwater 424.

The first movable cutwater 424 divides the flow of air within the internal volume 408 between the first exhaust 412 and a region of the internal volume 408 between the first cutwater 424 and the impeller 416. The first cutwater 424 is rotatable about an axis 426 and can thus be in various placements as it rotates. The first cutwater 424 is a cam wherein a minimum distance between the first cutwater 424 and the impeller can vary as the first cutwater rotates about the axis 426, thereby altering the air flow between the first exhaust 412 and the region of the internal volume 408 between the first cutwater 424 and the impeller 416.

The second movable cutwater 458 divides the flow of air within the internal volume 408 between the second exhaust 450 and a region of the internal volume 408 between the second cutwater 458 and the impeller 416. The second cutwater 458 is rotatable about an axis 462 and can thus be in various placements as it rotates. The second cutwater 458 is a cam wherein a minimum distance between the second cutwater 458 and the impeller can vary as the second cutwater rotates about the axis 462, thereby altering the air flow between the second exhaust 450 and the region of the internal volume 408 between the second cutwater 458 and the impeller 316.

FIGS. 4A and 4B illustrate the first and second cutwaters 424 and 458 in first and second placements, respectively, the first and second cutwaters rotating about the axes 426 and 462, respectively to move the cutwaters 424 and 458 from respective first placements to respective second placements. The minimum distance between the first cutwater 424 and the impeller 416 is a distance 428 in FIG. 4A and a distance 430 in FIG. 4B, the second distance 430 being less than the first distance 428. The first placement of the first cutwater 424 can be a default placement that the first cutwater is in when the system in which the fan 400 is located is operating under normal conditions and the second placement of the first cutwater 424 can be a placement of the first cutwater 424 is moved to when the system is executing a high-performance workload or operating in a high-performance mode. As the distance 430 is less than the distance 428, the amount of air flowing through the first exhaust 412 is greater during operation of the fan 400 when the first cutwater 424 is in the second placement due to the first cutwater 424 blocking more of the internal volume 408.

The second cutwater 458 can alter the air flow split between the second exhaust 450 and the region of the internal volume 408 between the impeller 416 and the second cutwater 458 by reducing a minimum distance 466 between the second exhaust 450 and the impeller 416 by reducing the air flow impedance presented by the second exhaust 450, or a combination of both. FIGS. 4A-4B illustrate the second cutwater 458 altering the air flow split by reducing the impedance presented by the second exhaust 450 by increasing the size of the second exhaust 450. The second placement of the second cutwater 458 in FIG. 4B presents a more open second exhaust 450 (and thus a lesser air flow impedance) than that presented by the second cutwater 458 in FIG. 4A. The cutwaters 424 and 458 can be moved from their respective first, default placements (FIG. 4A) to a second placement where the cutwaters are moved a maximum extent (FIG. 4B) in a single step or gradually. That is, in some embodiments, the cutwaters 424 and 458 can move to placements between the first and second placements indicated in FIGS. 4A and 4B.

In some embodiments, a dual outlet fan comprising first and second cutwaters can comprise an expandable housing portion, such as housing portion 332 of FIGS. 3A-3B, to provide for additional dynamic physical modification capabilities to the fan. The portion 332 can be expanded or contracted simultaneously with or independently from moving the first and second cutwaters 424 and 458.

FIGS. 5A-5D illustrate cross-sectional views of a fourth example dynamically modifiable air mover. The fan 500 is a triple outlet air mover with a single cutwater. The fan 500 comprises a housing 504 that defines an internal volume 508, a first exhaust 512, a second exhaust 550, and a third exhaust 570. The third exhaust 570 is located in a wall of the housing 504 that is adjacent to a wall of the housing 504 in which the second exhaust 550 is located. An impeller 516 rotates clockwise about a hub 520 during operation of the fan 500, drawing air into the impeller 516 through one or more inlets (not shown) and out the first, second, and (optionally) third exhausts 512, 550, and 570, as indicated by arrows 514, 554, and 574, respectively. The impeller 516 and the 520 are not centered within the internal volume 508 and are offset toward a movable cutwater 524.

The movable cutwater 524 divides the flow of air within the internal volume 508 between the first exhaust 512 and a region of the internal volume 508 between the cutwater 524 and the impeller 516. The cutwater 524 is rotatable about an axis 526 and can thus be in various placements as it rotates. The minimum distance between the cutwater 524 and the impeller can vary as the cutwater rotates about the axis 526, thereby altering the air flow between the first exhaust 512 and the region of the internal volume between first cutwater 524 and the impeller 516. A movable exhaust cover 578 can cover or uncover the third exhaust 570, depending on the workload being executed by the computing system within which the fan 500 is located. In some embodiments, air exiting the third exhaust 570 can be used to provide cooling to one or more memory components. The exhaust cover 578 can be in a first position that covers the third exhaust 570 when the system within which the fan 500 is located is not executing a memory-intensive workload and in one of one or more second positions in which the exhaust cover 578 leaves at least a portion of the third exhaust 570 uncovered. A cover actuator (not shown in FIGS. 5A-5D) can cause the exhaust cover 578 to move. The cover actuator can be any of the actuators described or referenced herein or any other suitable actuator.

FIG. 5A illustrates the fan 500 when the cutwater 524 is in a default placement. In embodiments where two instances of the fan 500 are used as the fans 124 in a laptop having a base design as illustrated in FIG. 1, the default position of the cutwater 524 can provide a desired balance between junction temperature cooling provided by air exiting the first exhaust 512 and skin temperature cooling provided by the second exhaust 550 when the laptop is operating in a normal operational mode.

FIG. 5B illustrates the fan 500 when the cutwater 524 is in a first placement that causes a decrease in the amount of air exiting the first exhaust 512 and an increase in the amount of air exiting the second exhaust 550, relative to when the cutwater 524 is in the default placement. In embodiments where two instances of the fan 500 are used as the fans 124 in a laptop having a base design as illustrated in FIG. 1, the cutwater 524 can be moved to the first placement to provide more skin temperature cooling, such as when the system within which the fan 500 is located is operating in a “cool” mode.

FIG. 5C illustrates the fan 500 when the cutwater 524 is in a second placement that causes an increase in the amount of air exiting the first exhaust 512 and a decrease in the amount of air exiting the second exhaust 550, relative to when the cutwater 524 is in the default placement. In embodiments where two instances of the fan 500 are used as the fans 124 in a laptop having a base design as illustrated in FIG. 1, the cutwater 524 can be moved to the second placement to provide more junction temperature cooling, such as in situations when the system within which the fan 500 is located is operating is in a high-performance operational mode or executing a high-performance workload.

FIG. 5D illustrates the fan 500 when the cutwater 524 is in a default placement and the third exhaust 570 is uncovered by the exhaust cover 578. In embodiments where two instances of the fan 500 are used as the fans 124 in a laptop having a base design as illustrated in FIG. 1, the third exhaust 570 is opened to allow the fans 500 to provide cooling to one or more memory integrated circuit components, as represented by air flow exiting optional third exhausts 170 providing cooling to memory components 178, as indicated by arrows 174.

Although FIGS. 5A-5D illustrate an exhaust 570 that can provide enhanced cooling to memory components in a fan with a single cutwater and two exhausts, an exhaust that provides enhanced cooling to memory components can be used in fans that have two cutwaters, one or two other exhausts, and/or an expandable portion of the fan housing that can alter the size of the internal volume of the fan (e.g., portion 332).

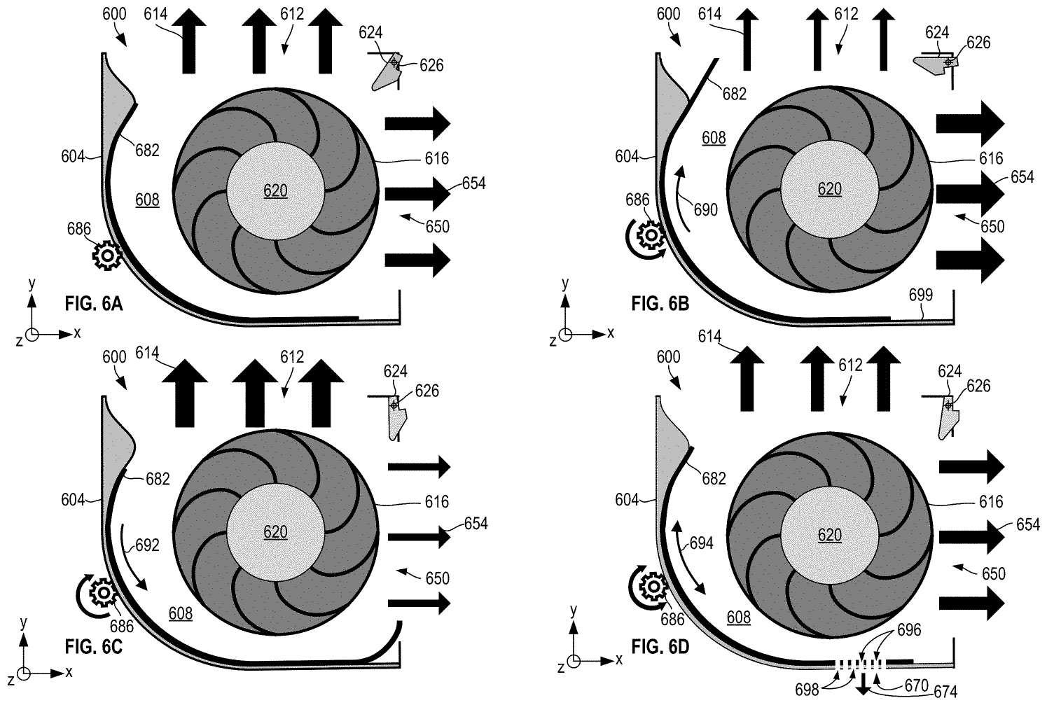

FIGS. 6A-6D illustrate cross-sectional views of a fifth example dynamically modifiable air mover. The fan 600 is a dual outlet air mover with a single cutwater and a movable flexible strip, both of which can adjust air flow splits within the fan 600. The fan 600 comprises a housing 604 that defines an internal volume 608, a first exhaust 612, and a second exhaust 650. An impeller 616 rotates clockwise about a hub 620 during operation of the fan 600, drawing air into the impeller 616 through one or more inlets (not shown) and out the first and second exhausts 612 and 650, as indicated by arrows 614 and 654, respectively. The impeller 616 and the 620 are not centered within the internal volume 608 and are offset toward a movable cutwater 624.

The movable cutwater 624 divides the flow of air within the internal volume 608 between the first exhaust 612 and a region of the internal volume 608 between the cutwater 624 and the impeller 616. The cutwater 624 is rotatable about an axis 626 and can thus be in various placements as it rotates. The minimum distance between the cutwater 624 and the impeller can vary as the cutwater rotates about the axis 626, thereby altering the air flow between the first exhaust 612 and the region of the internal volume between the first cutwater 624 and the impeller 616. The fan 600 further comprises a movable strip 682 that can alter the air flow split within the fan.

FIG. 6A illustrates the fan when the cutwater 624 and the strip 682 are in respective default placements. In its default placement, the strip 682 does not extend into (is withdrawn from) either the first exhaust 612 or the second exhaust 650. In embodiments where two instances of the fan 600 are used as the fans 124 in a laptop having a base design as illustrated in FIG. 1, the default position of the cutwater 624 and the strip 682 can provide a desired balance between junction temperature cooling provided by air exiting the first exhaust 612 and skin temperature cooling provided by the second exhaust 650 when the laptop is operating in a normal operational mode.

FIG. 6B illustrates the fan 600 when the cutwater 624 and the strip 682 are in respective first placements that cause a decrease in the amount of air exiting the first exhaust 612 and an increase in the amount of air exiting the second exhaust 650, relative to when the cutwater 624 and the strip 682 are in their respective default placements. In its first placement, a portion of the strip 682 extends into the first exhaust 612 and the strip 682 does not extend into (is withdrawn from) the second exhaust 650. In embodiments where two instances of the fan 600 are used as the fans 124 in a laptop having a base design as illustrated in FIG. 1, the cutwater 624 and the strip 682 can be moved to their respective first placements to provide more skin temperature cooling, such as when the system within which the fan 600 is located is operating in a “cool” mode.

FIG. 6C illustrates the fan 600 when the cutwater 624 and the strip 682 are in respective second placements that cause an increase in the amount of air exiting the first exhaust 612 and a decrease in the amount of air exiting the second exhaust 650, relative to when the cutwater 624 and the strip 682 are in their respective default placements. In its second placement, a portion of the strip 682 extends into the second exhaust 650 and the strip 682 does not extend into (is withdrawn from) the first exhaust 612. In embodiments where two instances of the fan 600 are used as the fans 124 in a laptop having a base design as illustrated in FIG. 1, the cutwater 624 and the strip 682 can be moved to their respective second placements to provide more junction temperature cooling, such as in situations when the system within which the fan 600 is located is operating is in a high-performance operational mode or executing a high-performance workload.

FIG. 6D illustrates a variation of the fan 600 comprising a third exhaust 670. The third exhaust 670 can provide enhanced cooling to one or more memory integrated circuit components located in the vicinity of the third exhaust 670 when the fan 600 is placed in a computing system. A plurality of slots 696 in the strip 682 can align with a plurality of slots 698 in the housing 604 that make up the third exhaust 670 to allow air to flow through the third exhaust 670, as indicated by arrow 674. Air is prevented from exiting through the third exhaust 670 by the strip 682 being moved into a position such that the slots 696 in the strip 682 do not align with the slots 698 in housing 604. In embodiments where two instances of the fan 600 are used as the fans 124 in a laptop having a base design as illustrated in FIG. 1 and having memory integrated circuit components located in a position where they are not cooled by a heat transfer device, such as memory integrated circuit components 178, the third exhaust 670 is opened (the slots 696 are aligned with the slots 698) to allow the fans 600 to provide cooling to one or more memory integrated circuit components, as represented in FIG. 1 by air flow exiting optional third exhausts 170 providing cooling to memory components 178, as indicated by arrows 174.

In some embodiments, the strip 682 can have multiple series of slots 696 located along its length to allow air to exit through the third exhaust 670 when the strip is in a default placement, extended into the first exhaust 612, or extended into the second exhaust 650. For example, strip 682 can be extended into the first exhaust 612 and the strip 682 can be moved in either direction (as indicated by arrow 694) a small distance to align or misalign slots in the strip 682 with the exhaust slots 698. This can allow for air flow through the third exhaust to be controlled while keeping the strip 682 in its default position, extended into the first exhaust 612, or extended into the second exhaust 650.

A strip actuator can cause the strip 682 to move between placements. The strip actuator is a rack-and-pinion actuator, as illustrated in FIGS. 6A-6D but can be another suitable actuator in other embodiments. The teeth of a gear 686 engaged with teeth (not shown) in the strip 682 to move the strip 682 in a desired direction. Rotation of the gear 686 counterclockwise causes the strip 682 to move toward the first exhaust 612, as indicated by arrows 690 in FIG. 6B, and rotation of the gear clockwise causes the strip 682 to move away from the first exhaust 612, as indicated by arrows 692 in FIG. 6C. In some embodiments, the flexible strip moves along at least a portion of an interior surface 699 of the fan housing, but in other embodiments, the strip 682 moves between placements without touching an interior surface of a wall of the fan housing.

Although FIGS. 6A-6D illustrate a strip that can dynamically modify the division of air flow in a fan along with a single cutwater, in other embodiments, such a strip can be used in dual outlet fans with two cutwaters (e.g., fan 400) or single outlet fans (e.g., fans 200, 300). In fans comprising a strip and one or two cutwaters to dynamically modify the fan, the strip can be moved simultaneously with or independently from the cutwaters. Further, the strip 682 can be placed in various placements that extend the strip 682 into the first exhaust 612 or the second exhaust 650 by varying amounts.

In some embodiment, a laptop having a base design as illustrated in FIG. 1 and having dynamically modifiable triple-outlet fans can have air distributions exiting the left, center, and right system exhausts 152, 162, and 158, shown in Table 1, for the various indicated workloads.

TABLE 1

| | Left | Center | Right |
|---|---|---|---|
| Workload | Exhaust | Exhaust | Exhaust |
| Default | 30% | 40% | 30% |
| Low Skin Temperature | 20% | 60% | 20% |
| High-Performance | 40% | 20% | 40% |
| Memory-intensive | 25% | 40% + 10% exiting | 25% |
| | | through separate exhaust | |
| | | to cool memory components | |

Any of the cutwaters described herein (e.g., 224, 324, 424, 458, 524, 624) can have any shape for which the cutwater being in various possible placements changes the minimum distance between the impeller and the cutwater. While a change in the minimum distance between the cutwater and the impeller can alter the air flow split between exhausts in a multi-outlet air mover or between an exhaust and a region of the internal volume of a fan between a cutwater and an impeller, the shape of the cutwater can also play a factor in how an air flow split can be varied as a cutwater is moved to a new placement. For example, cutwaters that are curved backward into the direction of air flow, curved forward into the direction of air flow, have an oblong shape, a round shape, or have the cam shape of FIGS. 2A-2B, 3A-3B, and 4A-4B can present surfaces with different shapes to air flowing between the cutwater and the impeller, and the shapes of these surfaces can vary as the cutwater is moved to a new placement. These differing surface shapes across cutwaters and varying surfacing shapes as a cutwater is moved to a new placement can result in varying air flow splits. Further, in some embodiments, the cutwater can be capable of being placed in more than two placements and the minimum distance between the cutwater and the impeller can be different for the various placements, thus allowing the fan to provide more than two different levels of air flow through the region of the internal volume between the impeller and the cutwater. Moreover, although some of the cutwaters are described and illustrated herein as being movable in that a cutwater rotates about an axis, in some embodiments, the movable cutwater is movable through translation, (movement of the cutwater in the x-y plane), rotation, or a combination of translation and rotation.

Any of the cutwaters described herein can be caused to be moved by an actuator (not shown in FIGS. 2A-2B, 3A-3B, 4A-4B, 5A-5D). A cutwater actuator can be a stepper motor (e.g., a micro high-precision stepper motor), a shape memory alloy-based actuator, or another suitable actuator. A shape memory alloy-based actuator can comprise one or more shape memory alloy (SMA) wires that change shape when heated (due to, for example, Joule heating), the changing shape of the SMA wires causing a cutwater to move. In some embodiments, the placement of a cutwater is controlled passively. For example, a cutwater can be held in a first placement by a spring when the amount of air flowing through the region of the internal volume of a fan between the impeller and the cutwater is less than an air flow threshold. When the air flow exceeds the air flow threshold, the aerodynamic forces pushing against the cutwater is greater than the spring force holding the cutwater in the first placement and the cutwater can move from its first placement toward a second placement. Increasing the amount of air flow above the air flow threshold pushes the cutwater further to the second placement.

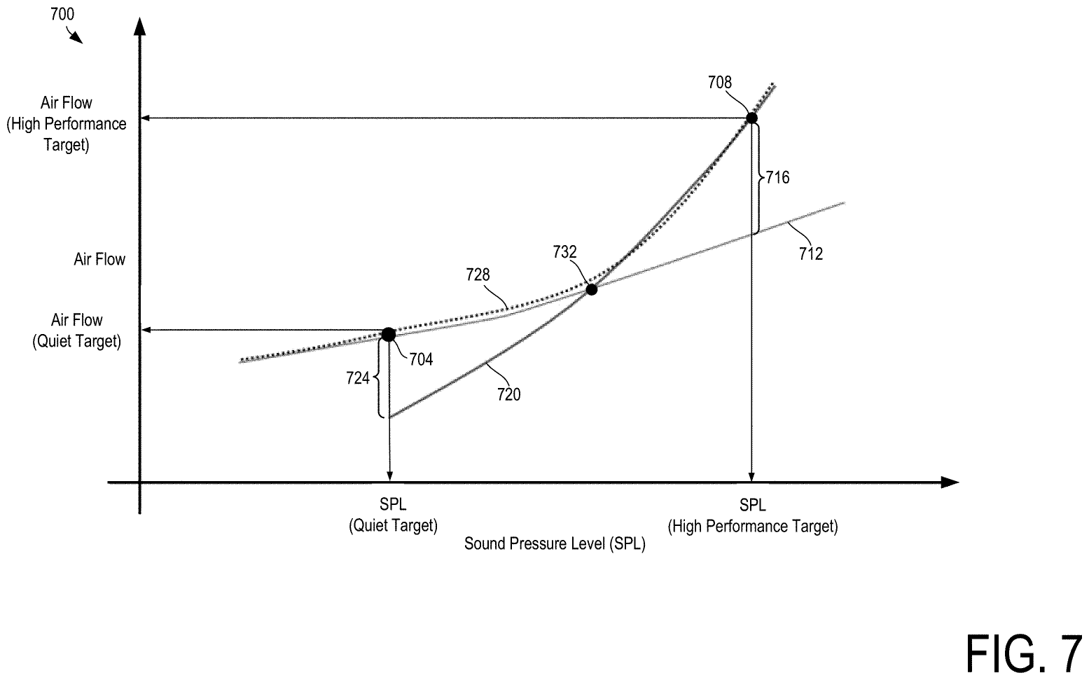

FIG. 7 is a graph showing the air flow versus sound pressure level curve for an example single outlet dynamically modifiable air mover. Points 704 and 708 in graph 700 are air flow targets for quiet and high-performance operational modes of a computing system, respectively. Curve 712 is the air flow versus sound pressure level curve for a fan tuned for the quiet operational mode. The curve 712 illustrates that a fan tuned for quiet performance (its air flow versus sound pressure level curve passes through point 704) falls short of providing the target air flow at the high-performance operational mode target 708 by an amount 716. Curve 720 is the air flow versus sound pressure level curve for a fan tuned for the high-performance operational mode and shows that a fan tuned for high performance (its air flow versus sound pressure level curve passes through point 708) falls short of providing the desired amount of air flow at the quiet operational mode target by an amount 724.

Curve 728 illustrates the air flow versus sound pressure level curve of a dynamically modified single outlet fan having a single cutwater that switches from a first placement to a second placement at point 732. At air flow levels below the air flow level of point 732, the cutwater is in a first placement (e.g., the first placement illustrated in FIG. 2A) and the fan performs similarly to a fan tuned for a quiet operational mode. At air flow levels above the air flow level of point 732, the cutwater moves to a second placement (e.g., the second placement illustrated in FIG. 2B), reducing the minimum distance between the cutwater and the impeller and the fan performs similar to a fan tuned for a high-performance operational mode. Thus, the dynamically modifiable fan whose performance is illustrated by curve 728 in graph 700 can provide target levels of fan performance for both quiet and high-performance operational modes of a computing system.

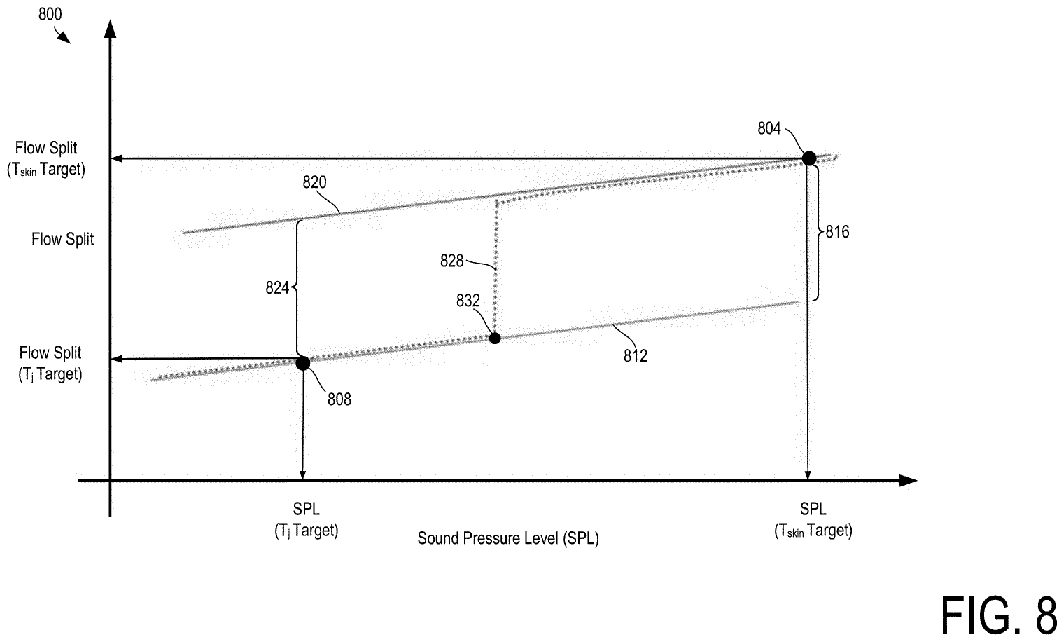

FIG. 8 is a graph showing the air flow split versus sound pressure level curve for an example dual outlet dynamically modifiable air mover. The graph 800 shows the flow split curve for a dual outlet air mover in a laptop base having a design as illustrated in FIG. 1. The flow split is measured as the ratio of the air flow passing through the exhaust positioned adjacent to a printed circuit board to provide hyperbaric cooling over the printed circuit board (such as second exhaust 134 in fans 124 pushing air into the core region 128 of the printed circuit board 104) to the total amount of air flowing through the two exhausts of the dual outlet fan.

Point 804 is an air flow split target for a fan tuned to provide enough air flow through the exhaust positioned adjacent to a printed circuit board to provide hyperbaric cooling over the printed circuit board temperature (e.g., second exhaust 134 positioned adjacent to core region 128 of printed circuit board 104) to achieve a target skin temperature (Tₛₖᵢₙ) cooling. Point 808 is an air flow split target for a fan tuned to provide enough air flow through the exhaust positioned adjacent to a heat exchanger (e.g., first exhaust positioned adjacent to fins 132) to provide sufficient junction temperature (Tⱼ) cooling to one or more integrated circuit components cooled in part by the heat exchanger.

Curve 812 illustrates the air flow split versus sound pressure level curve for a fan tuned for junction temperature cooling and passes through point 808. Curve 812 shows that a fan tuned for junction temperature cooling performance falls short of providing a desired air flow split at the exhaust positioned to provide skin temperature cooling under operating conditions where skin temperature cooling is prioritized. That is, the air flow split is below the target amount at point 804 by an amount 816. Curve 820 illustrates the air flow split versus sound pressure level curve for a fan tuned for skin temperature cooling and passes through point 804. Curve 820 shows that a fan tuned to provide skin temperature cooling falls short of providing a desired amount of air flow at the exhaust positioned adjacent to a heat exchanger to provide junction temperature cooling under operating conditions where junction temperature cooling is prioritized. That is, the air flow split is above the target amount at point 808 by an amount 824.

Curve 828 illustrates the characteristics of a dynamically modified dual outlet fan having a single cutwater that switches from a first placement to a second placement at point 832. At air flow levels below the air flow level associated with the sound pressure level at point 832, the cutwater is in a placement where it results in a lesser air flow split (e.g., the second cutwater placement illustrated in FIG. 3A) and the fan performs similarly to a fan tuned for junction temperature cooling. At air flow levels above the air flow level associated with the sound pressure level at point 832, the cutwater moves to a placement where it results in a greater air flow split (e.g., the first cutwater placement illustrated in FIG. 3B) and the fan performs similarly to a fan tuned for a high-performance operational mode. Thus, a dynamically modifiable fan whose performance is illustrated by curve 828 in graph 800 can provide target levels of skin temperature cooling and junction temperature cooling when needed by the system.

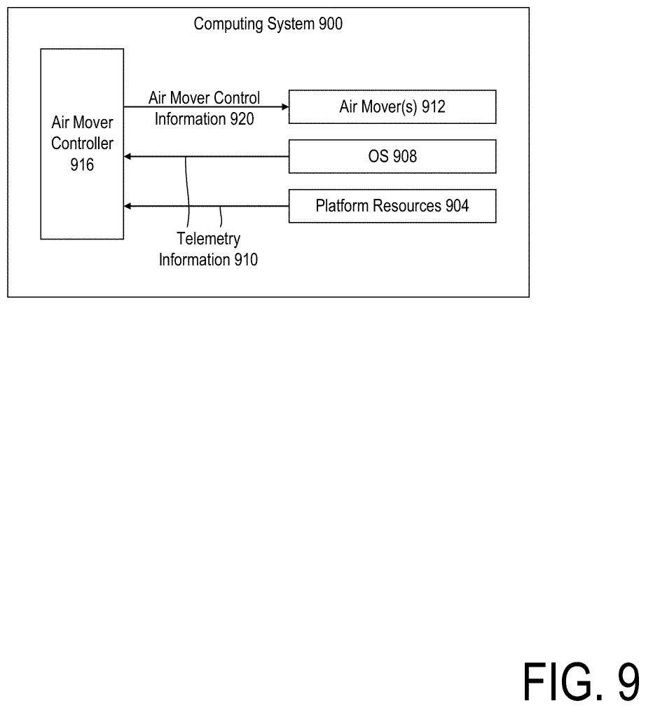

FIG. 9 is a block diagram of an example computing system comprising a dynamically modifiable air mover. The computing system 900 comprises platform resources 904, an operating system 908, one or more dynamically modifiable air movers 912, and an air mover controller 916. The platform resources 904 comprise one or more processors (e.g., CPUs, GPUs) and can include additional computing system components such as memories, storage units, I/O (input/output) controllers, and other computing system resources or components described or referenced herein. The platform resources 904 can further comprise platform-level components such as voltage regulators and a baseboard management controller (BMC). The one or more air movers 912 are part of the thermal management solution for cooling the computing system 900. In one embodiment, the computing system 900 is a laptop and the platform resources 904 comprise a CPU and GPU with a pair of dual outlet air movers 912 as part of the thermal management solution. The operating system 908 can be any type of operating system, such as a Windows- or Linux-based server operating system.

The air mover controller 916 can be firmware, software, hardware, or a combination thereof. In some embodiments, the air mover controller 916 can comprise air move controller circuitry. In some embodiments, the air mover controller 916 can be part of the operating system 908. In another example, the air mover controller 916 can be part of an Intel® Dynamic Tuning Technology (DTT) driver that is installed on the computing system 900. In yet another embodiment, the air mover controller 916 can be part of a platform-level component that manages hardware resources (e.g., integrated circuit components) of the computing system 900. The air mover controller 916 sends air mover control information 920 to the air movers 912. The air mover control information 920 can cause a physical modification to be made to the air mover (such as causing a cutwater of the air mover to be moved) and the air mover controller 916 can determine air mover control information 920 based on telemetry information provided by the platform resources 904 or information derived from the telemetry information 910.

The telemetry information 910 can be any information indicating a performance level of a processor unit (e.g., a core) within an integrated circuit component, an integrated circuit component, another component of the computing system 900, or the computing system 900 as a whole. The telemetry information 910 can comprise, for example, information indicating a power consumption level, a temperature, an operating voltage, an operating frequency, or an operational mode of a processor unit, an integrated circuit component, or any other component of the computing system 900, or the computing system 900. Telemetry information 910 indicating a temperature of the computing system 900 can indicate a skin temperature of the computing system 900.

The telemetry information 910 can be provided to the air mover controller 916 by the platform resource 904 (e.g., an integrated circuit component or another component, a baseboard management controller, a platform-level controller), the operating system 908 (such as via an operating system daemon), or by any other component in the computing system 900, such as a temperature sensor (e.g., thermistor) that provides information indicating the temperature of the skin of the computing system 900. For example, a temperature sensor or temperature-sensing component, such as a thermistor, could be located on an internal face of the computing system housing and information provided by the temperature sensor (or a response of a temperature-sensing component to a sensing signal) can indicate a skin temperature of the system. In some embodiments, the telemetry information 910 can be provided by plugins to an operating system daemon, such as the Linux collected daemon turbostat plugin, which can provide information about an integrated circuit component frequency, idle power-state statistics, temperature, power usage, etc.

In some embodiments, the telemetry information 910 can be made available by one or more performance counters or monitors. The performance counters or monitors can provide telemetry information at the processor unit or integrated circuit component level.

The telemetry information 910 can be provided to the air mover controller 916 at periodic (e.g., 1 second, 10 seconds) or other intervals, and the air mover controller 916 can cause physical modifications to the air movers at periodic (e.g., 1 second, 10 seconds) or other intervals as well. In some embodiments, the telemetry information 910 is pushed to the air mover controller 916 by the platform resources 904 or operating system 908 and in other embodiments the air mover controller 916 polls the platform resources 904 or operating system 908 for the telemetry information 910.

If the telemetry information 910 indicates that a temperature of a processor unit, integrated circuit component or another component, a skin temperature of the computing system 900, or another temperature of the computing system 900 exceeds a temperature threshold, the air mover controller 916 can cause a physical modification to be made to the air mover(s) 912. In some embodiments, the air mover controller 916 can determine a rate of temperature change based on the telemetry information indicating a temperature of the computing system. If the air mover controller 916 determines that a rate of change of the temperature of a processor unit, integrated circuit component or another component, a skin temperature of the computing system, or another temperature of the computing system exceeds a rate of temperature change threshold, the air mover controller 916 can cause a physical modification to be made to the air mover(s) 912.

If the telemetry information 910 indicates that a power consumption level of a processor unit, integrated circuit component or another component, or another power consumption level of the computing system 900 exceeds a power consumption level threshold, the air mover controller 916 can cause a physical modification to be made to the air mover(s) 912. In some embodiments, the air mover controller 916 can determine a rate of power consumption level change based on the telemetry information indicating a power consumption level. If the air mover controller 916 determines that a rate of change of the power consumption level of a processor unit, integrated circuit component or another component, or another power consumption level of the computing system 900 exceeds a rate of power consumption level change threshold, the air mover controller 916 can cause a physical modification to be made to the air mover(s) 912.

The air mover controller 916 can cause any of the air mover physical modifications described herein to be made to an air mover in response to determining that a temperature, temperature rate of change, power consumption level, or power consumption level rate of change exceeds a threshold. These physical modifications include moving one or more cutwaters from a first placement to a second placement to decrease the minimum distance between the cutwater and the impeller, expanding an expandable portion of a fan housing, uncovering a coverable exhaust, and moving a strip to extend into an exhaust.

The air mover controller 916 can further cause a physical modification to be made to an air mover 912 in response to the telemetry information 910 indicating that a temperature has fallen below a temperature threshold, that a power consumption level has fallen below a power consumption level, determining that a rate of temperature change has fallen below a rate of temperature change threshold, or determining that a rate of power consumption change has fallen below a rate of power consumption change threshold.

The air mover controller 916 can cause any of the physical modifications that can be made to an air mover 912 described herein in response to determining that a temperature, temperature rate of change, power consumption level, or power consumption level rate of change falls below a threshold. These physical modifications include moving one or more cutwaters from a first placement to a second placement to increase the minimum distance between the cutwater and the impeller, contracting an expandable portion of a fan housing, covering a coverable exhaust, and moving a strip to withdraw from an exhaust.

In some embodiments, the air mover controller 916 can dynamically modify a dual outlet fan comprising a single cutwater and a strip that can extend into either of the exhausts and uncover an exhaust that can provide cooling to memory components can operate as follows. If a “cool” operational mode is enabled, the air mover controller 916 can cause the cutwater to be moved to a placement where it reduces the minimum space between the cutwater and the impeller of the fan. The placement that the cutwater is moved to can be a function of the power consumption of a CPU or SoC (system-on-a-chip) of the computing system. That is, the greater the power consumption level of the CPU or SoC, the more the minimal distance between the cutwater and the impeller is reduced through movement of the cutwater.

If the telemetry information 910 indicates that the power consumption of one or more of the memory components (or the cumulative power consumption of the memory components) is greater than a power consumption threshold, the air mover controller 916 can cause the air mover 912 to move the exhaust cover to uncover the exhaust providing cooling to the memory components. The extent that the exhaust cover uncovers the exhaust providing cooling to the memory components can be a function of the power consumption of the memory components. That is, the greater the power consumption level of one or more of the memory components, the more that the exhaust cover is moved to uncover the exhaust providing cooling to the memory components.

If the memory power consumption is less than the power consumption threshold and the “cool” operational mode is not enabled, the cutwater is in a default placement and the exhaust cover covers the exhaust providing cooling for the memory components. In some embodiments, the air mover controller 916 can access a look-up table or other data structure to determine the air control information 920 it is to send to the air movers 912 to cause one or more actuators to cause a physical modification to the air movers.

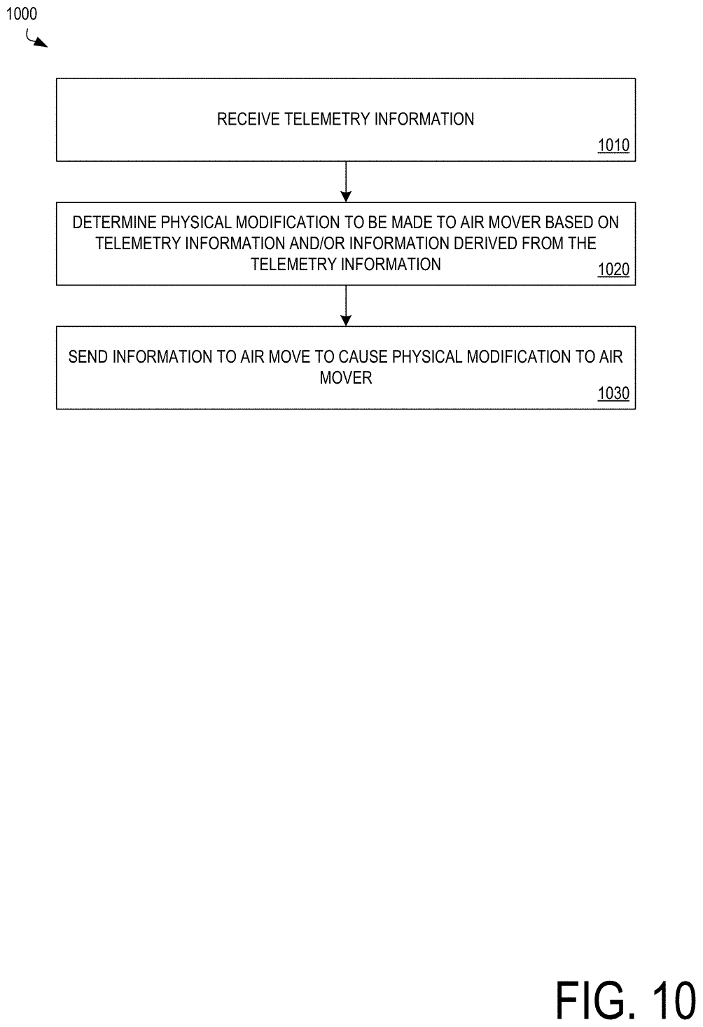

FIG. 10 is an example method of dynamically modifying an air mover in a computing system. The method 1000 can be performed by an air mover controller in a laptop computing system. At 1010, telemetry information is received. At 1020, a physical modification to an air mover located in a computing system is determined based on the telemetry information and/or information derived from the telemetry information. At 1030, air mover control information is sent to the air mover to cause the physical modification to the air mover.

The technologies described herein can be performed by or implemented in any of a variety of computing systems, including mobile computing systems (e.g., laptop computers, portable gaming consoles, 2-in-1 convertible computers, portable all-in-one computers), non-mobile computing systems (e.g., desktop computers, servers, workstations, stationary gaming consoles, set-top boxes, smart televisions, rack-level computing solutions (e.g., blade, tray, or sled computing systems)), and embedded computing systems (e.g., computing systems that are part of a vehicle, smart home appliance, consumer electronics product or equipment, manufacturing equipment). As used herein, the term “computing system” includes computing devices and includes systems comprising multiple discrete physical components. In some embodiments, the computing systems are located in a data center, such as an enterprise data center (e.g., a data center owned and operated by a company and typically located on company premises), managed services data center (e.g., a data center managed by a third party on behalf of a company), a colocated data center (e.g., a data center in which data center infrastructure is provided by the data center host and a company provides and manages their own data center components (servers, etc.)), cloud data center (e.g., a data center operated by a cloud services provider that host companies applications and data), and an edge data center (e.g., a data center, typically having a smaller footprint than other data center types, located close to the geographic area that it serves).

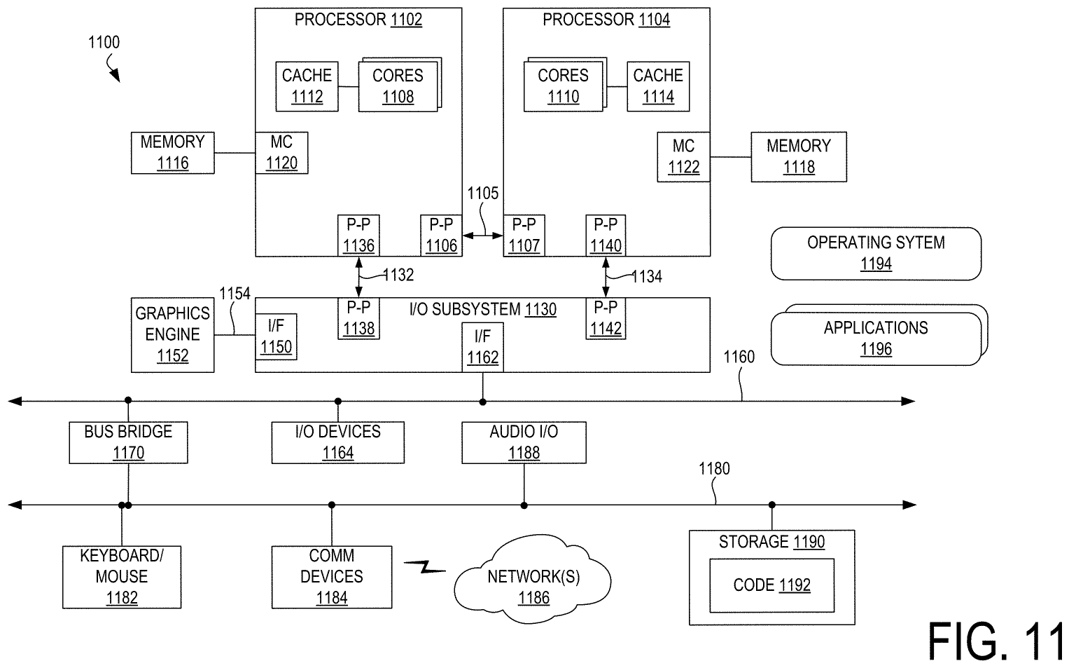

FIG. 11 is a block diagram of a second example computing system in which technologies described herein may be implemented. Generally, components shown in FIG. 11 can communicate with other shown components, although not all connections are shown, for ease of illustration. The computing system 1100 is a multiprocessor system comprising a first processor unit 1102 and a second processor unit 1104 comprising point-to-point (P-P) interconnects. A point-to-point (P-P) interface 1106 of the processor unit 1102 is coupled to a point-to-point interface 1107 of the processor unit 1104 via a point-to-point interconnection 1105. It is to be understood that any or all of the point-to-point interconnects illustrated in FIG. 11 can be alternatively implemented as a multi-drop bus, and that any or all buses illustrated in FIG. 11 could be replaced by point-to-point interconnects.

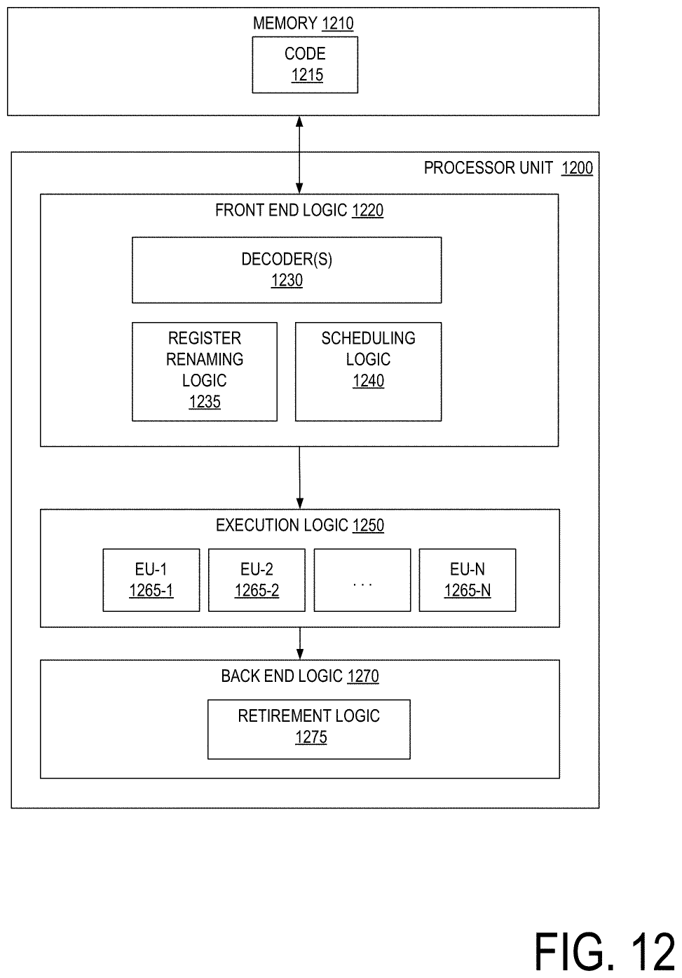

The processor units 1102 and 1104 comprise multiple processor cores. Processor unit 1102 comprises processor cores 1108 and processor unit 1104 comprises processor cores 1110. Processor cores 1108 and 1110 can execute computer-executable instructions in a manner similar to that discussed below in connection with FIG. 12, or other manners.

Processor units 1102 and 1104 further comprise cache memories 1112 and 1114, respectively. The cache memories 1112 and 1114 can store data (e.g., instructions) utilized by one or more components of the processor units 1102 and 1104, such as the processor cores 1108 and 1110. The cache memories 1112 and 1114 can be part of a memory hierarchy for the computing system 1100. For example, the cache memories 1112 can locally store data that is also stored in a memory 1116 to allow for faster access to the data by the processor unit 1102. In some embodiments, the cache memories 1112 and 1114 can comprise multiple cache levels, such as level 1 (L1), level 2 (L2), level 3 (L3), level 4 (L4) and/or other caches or cache levels. In some embodiments, one or more levels of cache memory (e.g., L2, L3, L4) can be shared among multiple cores in a processor unit or among multiple processor units in an integrated circuit component. In some embodiments, the last level of cache memory on an integrated circuit component can be referred to as a last level cache (LLC). One or more of the higher levels of cache levels (the smaller and faster caches) in the memory hierarchy can be located on the same integrated circuit die as a processor core and one or more of the lower cache levels (the larger and slower caches) can be located on an integrated circuit dies that are physically separate from the processor core integrated circuit dies.

Although the computing system 1100 is shown with two processor units, the computing system 1100 can comprise any number of processor units. Further, a processor unit can comprise any number of processor cores. A processor unit can take various forms such as a central processing unit (CPU), a graphics processing unit (GPU), general-purpose GPU (GPGPU), accelerated processing unit (APU), field-programmable gate array (FPGA), neural network processing unit (NPU), data processor unit (DPU), accelerator (e.g., graphics accelerator, digital signal processor (DSP), compression accelerator, artificial intelligence (AI) accelerator), controller, or other types of processing units. As such, the processor unit can be referred to as an XPU (or xPU). Further, a processor unit can comprise one or more of these various types of processing units. In some embodiments, the computing system comprises one processor unit with multiple cores, and in other embodiments, the computing system comprises a single processor unit with a single core. As used herein, the terms “processor unit” and “processing unit” can refer to any processor, processor core, component, module, engine, circuitry, or any other processing element described or referenced herein.

In some embodiments, the computing system 1100 can comprise one or more processor units that are heterogeneous or asymmetric to another processor unit in the computing system. There can be a variety of differences between the processing units in a system in terms of a spectrum of metrics of merit including architectural, microarchitectural, thermal, power consumption characteristics, and the like. These differences can effectively manifest themselves as asymmetry and heterogeneity among the processor units in a system.

The processor units 1102 and 1104 can be located in a single integrated circuit component (such as a multi-chip package (MCP) or multi-chip module (MCM)) or they can be located in separate integrated circuit components. An integrated circuit component comprising one or more processor units can comprise additional components, such as embedded DRAM, stacked high bandwidth memory (HBM), shared cache memories (e.g., L3, L4, LLC), input/output (I/O) controllers, or memory controllers. Any of the additional components can be located on the same integrated circuit die as a processor unit, or on one or more integrated circuit dies separate from the integrated circuit dies comprising the processor units. In some embodiments, these separate integrated circuit dies can be referred to as “chiplets”. In some embodiments where there is heterogeneity or asymmetry among processor units in a computing system, the heterogeneity or asymmetric can be among processor units located in the same integrated circuit component. In embodiments where an integrated circuit component comprises multiple integrated circuit dies, interconnections between dies can be provided by the package substrate, one or more silicon interposers, one or more silicon bridges embedded in the package substrate (such as Intel® embedded multi-die interconnect bridges (EMIBs)), or combinations thereof.

Processor units 1102 and 1104 further comprise memory controller logic (MC) 1120 and 1122. As shown in FIG. 11, MCs 1120 and 1122 control memories 1116 and 1118 coupled to the processor units 1102 and 1104, respectively. The memories 1116 and 1118 can comprise various types of volatile memory (e.g., dynamic random-access memory (DRAM), static random-access memory (SRAM)) and/or non-volatile memory (e.g., flash memory, chalcogenide-based phase-change non-volatile memories), and comprise one or more layers of the memory hierarchy of the computing system. While MCs 1120 and 1122 are illustrated as being integrated into the processor units 1102 and 1104, in alternative embodiments, the MCs can be external to a processor unit.

Processor units 1102 and 1104 are coupled to an Input/Output (I/O) subsystem 1130 via point-to-point interconnections 1132 and 1134. The point-to-point interconnection 1132 connects a point-to-point interface 1136 of the processor unit 1102 with a point-to-point interface 1138 of the I/O subsystem 1130, and the point-to-point interconnection 1134 connects a point-to-point interface 1140 of the processor unit 1104 with a point-to-point interface 1142 of the I/O subsystem 1130. Input/Output subsystem 1130 further includes an interface 1150 to couple the I/O subsystem 1130 to a graphics engine 1152. The I/O subsystem 1130 and the graphics engine 1152 are coupled via a bus 1154.

The Input/Output subsystem 1130 is further coupled to a first bus 1160 via an interface 1162. The first bus 1160 can be a Peripheral Component Interconnect Express (PCIe) bus or any other type of bus. Various I/O devices 1164 can be coupled to the first bus 1160. A bus bridge 1170 can couple the first bus 1160 to a second bus 1180. In some embodiments, the second bus 1180 can be a low pin count (LPC) bus. Various devices can be coupled to the second bus 1180 including, for example, a keyboard/mouse 1182, audio I/O devices 1188, and a storage device 1190, such as a hard disk drive, solid-state drive, or another storage device for storing computer-executable instructions (code) 1192 or data. The code 1192 can comprise computer-executable instructions for performing methods described herein. Additional components that can be coupled to the second bus 1180 include communication device(s) 1184, which can provide for communication between the computing system 1100 and one or more wired or wireless networks 1186 (e.g. Wi-Fi, cellular, or satellite networks) via one or more wired or wireless communication links (e.g., wire, cable, Ethernet connection, radio-frequency (RF) channel, infrared channel, Wi-Fi channel) using one or more communication standards (e.g., IEEE 1102.11 standard and its supplements).

In embodiments where the communication devices 1184 support wireless communication, the communication devices 1184 can comprise wireless communication components coupled to one or more antennas to support communication between the computing system 1100 and external devices. The wireless communication components can support various wireless communication protocols and technologies such as Near Field Communication (NFC), IEEE 1102.11 (Wi-Fi) variants, WiMax, Bluetooth, Zigbee, 4G Long Term Evolution (LTE), Code Division Multiplexing Access (CDMA), Universal Mobile Telecommunication System (UMTS) and Global System for Mobile Telecommunication (GSM), and 5G broadband cellular technologies. In addition, the wireless modems can support communication with one or more cellular networks for data and voice communications within a single cellular network, between cellular networks, or between the computing system and a public switched telephone network (PSTN).

The system 1100 can comprise removable memory such as flash memory cards (e.g., SD (Secure Digital) cards), memory sticks, Subscriber Identity Module (SIM) cards). The memory in system 1100 (including caches 1112 and 1114, memories 1116 and 1118, and storage device 1190) can store data and/or computer-executable instructions for executing an operating system 1194 and application programs 1196. Example data includes web pages, text messages, images, sound files, and video data to be sent to and/or received from one or more network servers or other devices by the system 1100 via the one or more wired or wireless networks 1186, or for use by the system 1100. The system 1100 can also have access to external memory or storage (not shown) such as external hard drives or cloud-based storage.

The operating system 1194 can control the allocation and usage of the components illustrated in FIG. 11 and support the one or more application programs 1196. The application programs 1196 can include common computing system applications (e.g., email applications, calendars, contact managers, web browsers, messaging applications) as well as other computing applications.

In some embodiments, a hypervisor (or virtual machine manager) operates on the operating system 1194 and the application programs 1196 operate within one or more virtual machines operating on the hypervisor. In these embodiments, the hypervisor is a type-2 or hosted hypervisor as it is running on the operating system 1194. In other hypervisor-based embodiments, the hypervisor is a type-1 or “bare-metal” hypervisor that runs directly on the platform resources of the computing system 1194 without an intervening operating system layer.

In some embodiments, the applications 1196 can operate within one or more containers. A container is a running instance of a container image, which is a package of binary images for one or more of the applications 1196 and any libraries, configuration settings, and any other information that one or more applications 1196 need for execution. A container image can conform to any container image format, such as Docker®, Appc, or LXC container image formats. In container-based embodiments, a container runtime engine, such as Docker Engine, LXU, or an open container initiative (OCI)-compatible container runtime (e.g., Railcar, CRI-O) operates on the operating system (or virtual machine monitor) to provide an interface between the containers and the operating system 1194. An orchestrator can be responsible for management of the computing system 1100 and various container-related tasks such as deploying container images to the computing system 1194, monitoring the performance of deployed containers, and monitoring the utilization of the resources of the computing system 1194.

The computing system 1100 can support various additional input devices, such as a touchscreen, microphone, monoscopic camera, stereoscopic camera, trackball, touchpad, trackpad, proximity sensor, light sensor, and one or more output devices, such as one or more speakers or displays. Other possible input and output devices include piezoelectric and other haptic I/O devices. Any of the input or output devices can be internal to, external to, or removably attachable with the system 1100. External input and output devices can communicate with the system 1100 via wired or wireless connections.

The system 1100 can further include at least one input/output port comprising physical connectors (e.g., USB, IEEE 1394 (FireWire), Ethernet, RS-232), a power supply (e.g., battery), a global satellite navigation system (GNSS) receiver (e.g., GPS receiver); a gyroscope; an accelerometer; and/or a compass. A GNSS receiver can be coupled to a GNSS antenna. The computing system 1100 can further comprise one or more additional antennas coupled to one or more additional receivers, transmitters, and/or transceivers to enable additional functions.

In addition to those already discussed, integrated circuit components, integrated circuit constituent components, and other components in the computing system 1194 can communicate with interconnect technologies such as Intel® QuickPath Interconnect (QPI), Intel® Ultra Path Interconnect (UPI), Computer Express Link (CXL), cache coherent interconnect for accelerators (CCTV)), serializer/deserializer (SERDES), Nvidia® NVLink, ARM Infinity Link, Gen-Z, or Open Coherent Accelerator Processor Interface (OpenCAPI). Other interconnect technologies may be used and a computing system 1194 may utilize more or more interconnect technologies.

It is to be understood that FIG. 11 illustrates only one example computing system architecture. Computing systems based on alternative architectures can be used to implement technologies described herein. For example, instead of the processors 1102 and 1104 and the graphics engine 1152 being located on discrete integrated circuits, a computing system can comprise an SoC (system-on-a-chip) integrated circuit incorporating multiple processors, a graphics engine, and additional components. Further, a computing system can connect its constituent component via bus or point-to-point configurations different from that shown in FIG. 11. Moreover, the illustrated components in FIG. 11 are not required or all-inclusive, as shown components can be removed and other components added in alternative embodiments.

FIG. 12 is a block diagram of an example processor unit to execute computer-executable instructions as part of implementing technologies described herein. The processor unit 1200 can be a single-threaded core or a multithreaded core in that it may include more than one hardware thread context (or “logical processor”) per processor unit.

FIG. 12 also illustrates a memory 1210 coupled to the processor unit 1200. The memory 1210 can be any memory described herein or any other memory known to those of skill in the art. The memory 1210 can store computer-executable instructions 1215 (code) executable by the processor unit 1200.

The processor unit comprises front-end logic 1220 that receives instructions from the memory 1210. An instruction can be processed by one or more decoders 1230. The decoder 1230 can generate as its output a micro-operation such as a fixed width micro-operation in a predefined format, or generate other instructions, microinstructions, or control signals, which reflect the original code instruction. The front-end logic 1220 further comprises register renaming logic 1235 and scheduling logic 1240, which generally allocate resources and queues operations corresponding to converting an instruction for execution.

The processor unit 1200 further comprises execution logic 1250, which comprises one or more execution units (EUs) 1265-1 through 1265-N. Some processor unit embodiments can include a number of execution units dedicated to specific functions or sets of functions. Other embodiments can include only one execution unit or one execution unit that can perform a particular function. The execution logic 1250 performs the operations specified by code instructions. After completion of execution of the operations specified by the code instructions, back-end logic 1270 retires instructions using retirement logic 1275. In some embodiments, the processor unit 1200 allows out of order execution but requires in-order retirement of instructions. Retirement logic 1275 can take a variety of forms as known to those of skill in the art (e.g., re-order buffers or the like).

The processor unit 1200 is transformed during execution of instructions, at least in terms of the output generated by the decoder 1230, hardware registers and tables utilized by the register renaming logic 1235, and any registers (not shown) modified by the execution logic 1250.

As used herein, the term “circuitry” can comprise, singly or in any combination, non-programmable (hardwired) circuitry, programmable circuitry such as processor units, state machine circuitry, and/or firmware that stores instructions executable by programmable circuitry.

Any of the disclosed methods (or a portion thereof) can be implemented as computer-executable instructions or a computer program product. Such instructions can cause a computing system or one or more processor units capable of executing computer-executable instructions to perform any of the disclosed methods. As used herein, the term “computer” refers to any computing system, device, or machine described or mentioned herein as well as any other computing system, device, or machine capable of executing instructions. Thus, the term “computer-executable instruction” refers to instructions that can be executed by any computing system, device, or machine described or mentioned herein as well as any other computing system, device, or machine capable of executing instructions. A computing system referred to as being programmed to perform a method can be programmed to perform the method via software, hardware, firmware, or combinations thereof.

The computer-executable instructions or computer program products as well as any data created and/or used during implementation of the disclosed technologies can be stored on one or more tangible or non-transitory computer-readable storage media, such as volatile memory (e.g., DRAM, SRAM), non-volatile memory (e.g., flash memory, chalcogenide-based phase-change non-volatile memory) optical media discs (e.g., DVDs, CDs), and magnetic storage (e.g., magnetic tape storage, hard disk drives). Computer-readable storage media can be contained in computer-readable storage devices such as solid-state drives, USB flash drives, and memory modules. Alternatively, any of the methods disclosed herein (or a portion) thereof may be performed by hardware components comprising non-programmable circuitry. In some embodiments, any of the methods herein can be performed by a combination of non-programmable hardware components and one or more processing units executing computer-executable instructions stored on computer-readable storage media.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C #, Java, Perl, Python, JavaScript, Adobe Flash, C #, assembly language, or any other programming language. Likewise, the disclosed technologies are not limited to any particular computer system or type of hardware.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

As used in this application and the claims, a list of items joined by the term “and/or” can mean any combination of the listed items. For example, the phrase “A, B and/or C” can mean A; B; C; A and B; A and C; B and C; or A, B and C. As used in this application and the claims, a list of items joined by the term “at least one of” can mean any combination of the listed terms. For example, the phrase “at least one of A, B or C” can mean A; B; C; A and B; A and C; B and C; or A, B, and C. Moreover, as used in this application and the claims, a list of items joined by the term “one or more of” can mean any combination of the listed terms. For example, the phrase “one or more of A, B and C” can mean A; B; C; A and B; A and C; B and C; or A, B, and C.

The disclosed methods, apparatuses, and systems are not to be construed as limiting in any way. Instead, the present disclosure is directed toward all novel and nonobvious features and aspects of the various disclosed embodiments, alone and in various combinations and subcombinations with one another. The disclosed methods, apparatuses, and systems are not limited to any specific aspect or feature or combination thereof, nor do the disclosed embodiments require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

Although the operations of some of the disclosed methods are described in a particular, sequential order for convenient presentation, it is to be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

As used in this application and the claims, the phrase “individual of” or “respective of” followed by a list or plurality of items recited or stated as having a trait, feature, etc. means that all the items in the list possess the stated or recited trait, feature, etc. For example, the phrase “individual of A, B, or C, are circular” or “respective of A, B, or C, are circular” means that A is circular, B is circular, and C is circular.

The following examples pertain to additional embodiments of technologies disclosed herein.

Example 1 includes an apparatus, comprising an impeller capable of rotating; a housing defining an internal volume and an exhaust, the impeller located within the internal volume; and a cutwater to divide a flow of air within the internal volume between the exhaust and a region of the internal volume between the cutwater and the impeller, wherein the cutwater is capable of moving, wherein a minimum distance between the cutwater and the impeller is a first distance when the cutwater is in a first cutwater placement and a second distance when the cutwater is in a second cutwater placement, and wherein the first distance is greater than the second distance.

Example 2 includes the subject matter of Example 1, and wherein the cutwater is to move from the first cutwater placement to the second cutwater placement through rotation of the cutwater.

Example 3 includes the subject matter of any of Examples 1 and 2, and wherein the cutwater is to move from the first cutwater placement to the second cutwater placement through translation of the cutwater.

Example 4 includes the subject matter of any of Examples 1-3, and further including a stepper motor to cause the cutwater to move between the first cutwater placement and the second cutwater placement.

Example 5 includes the subject matter of any of Examples 1-4, and further including an actuator comprising one or more shape memory alloy wires, wherein heating or cooling of the shape memory alloy wires is to cause the cutwater to move between the first cutwater placement and the second cutwater placement.

Example 6 includes the subject matter of any of Examples 1-5, and further including a spring attached to the cutwater, wherein a spring force of the spring is to hold the cutwater in the first cutwater placement when the spring force is greater than aerodynamic forces pushing against the cutwater, and wherein the cutwater is to move toward the second cutwater placement when the aerodynamic forces pushing against the cutwater are greater than the spring force holding the cutwater in the first cutwater placement.

Example 7 includes the subject matter of any of Examples 1-6, and wherein the cutwater comprises a cam.

Example 8 includes the subject matter of any of Examples 1-7, and wherein the impeller is not centered within the internal volume.

Example 9 includes the subject matter of any one of Examples 1-8, wherein the exhaust is a first exhaust, and wherein the apparatus further comprises a second exhaust, an exhaust cover capable of moving between a first exhaust cover position in which the exhaust cover covers the second exhaust and one or more second exhaust cover positions in which the exhaust cover leaves at least a portion of the second exhaust uncovered.

Example 10 includes the subject matter of any one of Examples 1-8, wherein the exhaust is a first exhaust, the apparatus further comprising a second exhaust, wherein the cutwater is located between the first exhaust and the second exhaust.

Example 11 includes the subject matter of any of Examples 1-10, and wherein the cutwater is a first cutwater and the apparatus further comprising a second cutwater, wherein the second exhaust is located between the first cutwater and the second cutwater, wherein the second cutwater is to divide the flow of air within the internal volume between the second exhaust and a region of the internal volume between the second cutwater and the impeller, wherein the second cutwater is capable of moving, wherein a minimum distance between the second cutwater and the impeller is a third distance when the second cutwater is in a third placement and a fourth distance when the second cutwater is in a fourth placement, and wherein the third distance is greater than the fourth distance.

Example 12 includes the subject matter of Examples 10 or 11, wherein the first exhaust is located in a first wall of the housing and the second exhaust is located in a second wall of the housing that is located adjacent to the first wall.

Example 13 includes the subject matter of any of Examples 1-12, and wherein the second wall is substantially orthogonal to the first wall.

Example 14 includes the subject matter of any one of Examples 11-13, wherein the second cutwater is to move from the third placement to the fourth placement through rotation of the second cutwater.

Example 15 includes the subject matter of any one of Examples 11-13, wherein the second cutwater is to move from the third placement to the fourth placement through translation of the second cutwater.

Example 16 includes the subject matter of any one of Examples 11-15, further comprising a stepper motor to cause the second cutwater to move between the third placement and the fourth placement.

Example 17 includes the subject matter of any one of Examples 11-15, further comprising a second cutwater actuator comprising one or more shape memory alloy wires, wherein heating or cooling of the shape memory alloy wires of the second cutwater actuator is to cause the second cutwater to move between the third placement and the fourth placement.

Example 18 includes the subject matter of any one of Examples 11-15, further comprising a second cutwater spring attached to the second cutwater, wherein a spring force of the second cutwater spring is to hold the second cutwater in the third placement when the spring force is greater than aerodynamic forces pushing against the second cutwater, and wherein the second cutwater is to move toward the fourth placement when the aerodynamic forces pushing against the second cutwater are greater than the spring force holding the second cutwater in the third placement.

Example 19 includes the subject matter of any one of Examples 11-18, wherein the second cutwater comprises a cam.

Example 20 includes the subject matter of any one of Examples 10-19, the apparatus further comprising a third exhaust, an exhaust cover capable of moving between a first exhaust cover position in which the exhaust cover covers the third exhaust and one or more second exhaust cover positions in which the exhaust cover leaves at least a portion of the third exhaust uncovered.

Example 21 includes the subject matter of any of Examples 1-20, and wherein the first exhaust is located in a first wall of the housing that is opposite from a second wall of the housing in which the third exhaust is located.

Example 22 includes the subject matter of claim 9, 20, or 21, further comprising an actuator to cause the exhaust cover to move between the first exhaust cover placement and one of the second exhaust cover placements.

Example 23 includes an apparatus, comprising an impeller; and a housing defining an internal volume and an exhaust, wherein the impeller is located within the internal volume, wherein a portion of the housing is capable of moving from a first housing portion placement in which the internal volume is a first volume to a second housing portion placement in which the internal volume is a second volume, and wherein the second volume is greater than the first volume.

Example 24 includes the subject matter of Example 23, and further including an actuator to cause the portion of the housing to move between the first housing portion placement and the second housing portion placement.

Example 25 includes the subject matter of any of Examples 23 and 24, and wherein the actuator comprises one or more shape memory alloy wires, and wherein heating or cooling of the shape memory alloy wires is to cause the portion of the housing to move between the first housing portion placement and the second housing portion placement.

Example 26 includes the subject matter of any one of Examples 23-25, wherein the portion of the housing comprises flexible, stretchable, and/or expandable material.

Example 27 includes the subject matter of any one of Examples 23-26, further comprising a cutwater to divide a flow of air within the internal volume between the exhaust and a region of the internal volume between the cutwater and the impeller, wherein the cutwater is movable, wherein a minimum distance between the cutwater and the impeller is a first distance when the cutwater is in a first cutwater placement and a second distance when the cutwater is in a second cutwater placement, and wherein the first distance is greater than the second distance.

Example 28 includes the subject matter of any of Examples 23-27, and further including a cutwater actuator to cause the cutwater to move between the first cutwater placement and the second cutwater placement.

Example 29 includes the subject matter of any of Examples 23-28, and wherein the cutwater actuator comprises a stepper motor to cause the cutwater to move between the first cutwater placement and the second cutwater placement.

Example 30 includes the subject matter of any of Examples 23-29, and wherein the cutwater actuator comprises one or more shape memory alloy wires, wherein heating or cooling of the shape memory alloy wires is to cause the cutwater to move between the first cutwater placement and the second cutwater placement.

Example 31 includes the subject matter of any of Examples 23-30, and further including a first cutwater spring attached to the cutwater, wherein a spring force of the first cutwater spring is to hold the cutwater in the first cutwater placement when the spring force is greater than aerodynamic forces pushing against the cutwater, and wherein the cutwater is to move toward the second cutwater placement when the aerodynamic forces pushing against the cutwater are greater than the spring force holding the cutwater in the first cutwater placement.

Example 32 includes the subject matter of any one of Examples 27-31, wherein the cutwater comprises a cam.

Example 33 includes the subject matter of any one of Examples 27-32, wherein the exhaust is a first exhaust, wherein the apparatus further comprises a second exhaust, and wherein the cutwater is located between the first exhaust and the second exhaust.

Example 34 includes the subject matter of any of Examples 23-33, and wherein the cutwater is a first cutwater, wherein the apparatus comprises a second cutwater, wherein the second exhaust is located between the first cutwater and the second cutwater, wherein the second cutwater is to divide the flow of air within the internal volume between the second exhaust and a region of the internal volume between the second cutwater and the impeller, wherein the second cutwater is movable, wherein a minimum distance between the second cutwater and the impeller is a third distance when the second cutwater is in a third placement and a fourth distance when the second cutwater is in a fourth placement, and wherein the third distance is greater than the fourth distance.

Example 35 includes the subject matter of claim 33 or 34, further comprising a second cutwater actuator to cause the second cutwater to move between the third placement and the fourth placement.

Example 36 includes the subject matter of any of Examples 23-35, and wherein the second cutwater actuator comprises a second cutwater actuator stepper motor to cause the second cutwater to move between the third placement and the fourth placement.

Example 37 includes the subject matter of any of Examples 23-36, and wherein the second cutwater actuator comprises one or more shape memory alloy wires, wherein heating or cooling of the shape memory alloy wires of the second cutwater actuator is to cause the second cutwater to move between the third placement and the fourth placement.

Example 38 includes the subject matter of any of Examples 23-37, and further including a second cutwater spring attached to the second cutwater, wherein a spring force of the second cutwater spring is to hold the second cutwater in the third placement when the spring force is greater than aerodynamic forces pushing against the second cutwater, and wherein the second cutwater is to move toward the fourth placement when the aerodynamic forces pushing against the second cutwater are greater than the spring force holding the second cutwater in the third placement.

Example 39 includes the subject matter of any one of Examples 34-38, wherein the second cutwater comprises a cam.

Example 40 includes an apparatus comprising an impeller; a housing, defining an internal volume, a first exhaust, and a second exhaust, wherein the impeller is located within the internal volume; and a strip located within the internal volume of the housing, wherein the strip is movable, and wherein the strip extends into the first exhaust in a first strip placement and extends into the second exhaust in a second strip placement.

Example 41 includes the subject matter of Example 40, and wherein a portion of the strip is capable of moving along a surface of an interior surface of the housing.

Example 42 includes the subject matter of any of Examples 40 and 41, and wherein the strip is flexible.

Example 43 includes the subject matter of any of Examples 40-42, and further including an actuator to cause the strip to move between the first strip placement and the second strip placement.

Example 44 includes the subject matter of any of Examples 40-43, and wherein the strip comprises first teeth and the actuator comprises a gear comprising second teeth to engage with the first teeth.

Example 45 includes the subject matter of any one of Examples 40-44, further comprising a cutwater to divide a flow of air within the internal volume between the first exhaust and the second exhaust, wherein the cutwater is movable, wherein a minimum distance between the cutwater and the impeller is a first distance when the cutwater is in a first cutwater placement and a second distance when the cutwater is in a second cutwater placement, wherein the first distance is greater than the second distance, and wherein the cutwater is positioned between the first exhaust and the second exhaust.

Example 46 includes the subject matter of any of Examples 40-45, and further including a stepper motor to cause the cutwater to move between the first cutwater placement and the second cutwater placement.

Example 47 includes the subject matter of any of Examples 40-46, and further including an actuator comprising one or more shape memory alloy wires, wherein heating or cooling of the shape memory alloy wires is to cause the cutwater to move between the first cutwater placement and the second cutwater placement.

Example 48 includes the subject matter of any of Examples 40-47, and further including a spring attached to the cutwater, wherein a spring force of the spring is to hold the cutwater in the first cutwater placement when the spring force is greater than aerodynamic forces pushing against the cutwater, and wherein the cutwater is to move toward the second cutwater placement when the aerodynamic forces pushing against the cutwater are greater that the spring force holding the cutwater in the first cutwater placement.

Example 49 includes the subject matter of any one of Examples 40-48, wherein the cutwater comprises a cam.

Example 50 includes the subject matter of any one of Examples 40-49, further comprising a third exhaust comprising a plurality of slots, wherein the strip comprises a plurality of slots, and wherein the strip is further capable of moving to a third placement in which the slots of the strip align with the slots of the third exhaust.

Example 51 includes the subject matter of any of Examples 40-50, and wherein the first exhaust is located in a first wall of the housing that is opposite from a second wall of the housing in which the third exhaust is located.

Example 52 includes the subject matter of any one of Examples 40-51, further comprising a strip actuator to cause the strip to move between the first strip placement and the second strip placement.

Example 53 includes the subject matter of any one of Examples 1-52, wherein the housing is an air mover housing, the apparatus further comprising a printed circuit board; one or more processing units attached to the printed circuit board; a heat transfer device located on the one or more processing units; and a system housing enclosing the processing units, the heat transfer device, the air mover housing and the printed circuit board.

Example 54 includes the subject matter of any of Examples 40-53, and wherein the heat transfer device is a vapor chamber.

Example 55 includes a system comprising a first air mover comprising a first exhaust and a second exhaust; a second air mover comprising a third exhaust and a fourth exhaust; a printed circuit board comprising a core region positioned between the first air mover and the second air mover, wherein the first air mover and the second air mover are positioned to direct air existing the second exhaust and the fourth exhaust toward the core region; one or more processor units attached to the core region of the printed circuit board; a heat transfer device located on the one or more processor units; a first heat exchanger attached to the heat transfer device and positioned adjacent to the first exhaust; and a second heat exchanger attached to the heat transfer device and positioned adjacent to the third exhaust.

Example 56 includes the subject matter of Example 55, and wherein the first air mover comprises a first impeller; a first housing defining a first internal volume, the first exhaust, and the second exhaust, wherein the first impeller located is within the first internal volume; and a first cutwater to divide a flow of air within the first internal volume between the first exhaust and a region of the first internal volume between the first cutwater and the first impeller, wherein the first cutwater is movable, wherein a minimum distance between the first cutwater and the first impeller is a first distance when the first cutwater is in a first cutwater placement and a second distance when the first cutwater is in a second cutwater placement, wherein the first distance is greater than the second distance, and wherein the first cutwater positioned between the first exhaust and the second exhaust; and the second air mover comprises a second impeller; a second housing defining a second internal volume, the third exhaust, and the fourth exhaust, wherein the second impeller located is within the second internal volume; and a second cutwater to divide the flow of air within the second internal volume between the third exhaust and a region of the second internal volume between the second cutwater and the second impeller, wherein the second cutwater is movable, wherein a minimum distance between the second cutwater and the second impeller is a third distance when the second cutwater is in a second cutwater placement and a fourth distance when the second cutwater is in a fourth cutwater placement, and wherein the third distance is greater than the fourth distance, the second cutwater positioned between the third exhaust and the fourth exhaust.

Example 57 includes the subject matter of claim 55 or 56, further comprising a first stepper motor to cause the first cutwater to move between the first cutwater placement and the second cutwater placement.

Example 58 includes the subject matter of claim 55 or 56, further comprising a first cutwater actuator comprising one or more shape memory alloy wires, wherein heating or cooling of the shape memory alloy wires is to cause the first cutwater to move between the first cutwater placement and the second cutwater placement.

Example 59 includes the subject matter of claim 55 or 56, further comprising a first spring attached to the first cutwater, wherein a spring force of the first spring is to hold the first cutwater in the first cutwater placement when the spring force is greater than aerodynamic forces pushing against the first cutwater, and wherein the first cutwater is to move toward the second cutwater placement when the aerodynamic forces pushing against the first cutwater are greater than the spring force holding the first cutwater in the first cutwater placement.

Example 60 includes the subject matter of any one of Examples 55-59, wherein the first cutwater comprises a cam.

Example 61 includes the subject matter of any one of Examples 56-60, wherein the first air mover further comprises a third cutwater to divide the flow of air within the first internal volume between the first exhaust and the region of the first internal volume between the third cutwater and the first impeller, wherein the third cutwater is movable, wherein a minimum distance between the third cutwater and the first impeller is a fifth distance when the third cutwater is in a fifth placement and a sixth distance when the third cutwater is in a sixth placement, wherein the fifth distance is greater than the sixth distance, wherein the third cutwater is positioned between the first exhaust and the second exhaust, wherein the second air mover comprises a fourth cutwater to divide the flow of air within the second internal volume between the third exhaust and a region of the second internal volume between the fourth cutwater and the second impeller, wherein a minimum distance between the fourth cutwater and the second impeller is a seventh distance when the fourth cutwater is in a seventh placement and an eighth distance when the fourth cutwater is in an eighth placement, wherein the seventh distance is greater than the eighth distance, and wherein the fourth cutwater positioned between the third exhaust and the fourth exhaust.

Example 62 includes the subject matter of any of Examples 55-61, and further including a third cutwater actuator to cause the third cutwater to move between the fifth placement and the sixth placement.

Example 63 includes the subject matter of any of Examples 55-62, and wherein the third cutwater actuator comprises a stepper motor to cause the third cutwater to move between the fifth placement and the sixth placement.

Example 64 includes the subject matter of any of Examples 55-63, and wherein the third cutwater actuator comprises one or more shape memory alloy wires, wherein heating or cooling of the shape memory alloy is to cause the third cutwater to move between the fifth placement and the sixth placement.

Example 65 includes the subject matter of any of Examples 55-64, and further including a second spring attached to the third cutwater, wherein a spring force of the second spring is to hold the third cutwater in the fifth placement when the spring force is greater than aerodynamic forces pushing against the third cutwater, and wherein the third cutwater to move toward the sixth placement when the aerodynamic forces pushing against the third cutwater are greater that the spring force holding the third cutwater in the fifth placement.

Example 66 includes the subject matter of any one of Examples 61-65, wherein the third cutwater comprises a cam.

Example 67 includes the subject matter of any of Examples 55-66, and wherein the first air mover comprises a first impeller; a first housing defining a first internal volume, the first exhaust, and the second exhaust, wherein the first impeller is located within the first internal volume, wherein a portion of the first housing located adjacent to the first exhaust is capable of expanding from a first placement in which the first exhaust has a first exhaust size to a second placement in which the first exhaust has a second exhaust size, and wherein the second exhaust size is greater than the first exhaust size; and the second air mover comprises a second impeller; a second housing defining a second internal volume, the third exhaust, and the fourth exhaust, wherein the second impeller is located within the second internal volume, wherein a portion of the second housing located adjacent to the third exhaust is capable of expanding from a third position in which the third exhaust has a third exhaust size to a fourth placement in which the fourth exhaust has a fourth exhaust size, and wherein the fourth exhaust size greater than the third exhaust size.

Example 68 includes the subject matter of any of Examples 55-67, and further including an actuator to cause the portion of the first housing to move between the first placement and the second placement.

Example 69 includes the subject matter of any of Examples 55-68, and wherein the actuator comprises one or more shape memory alloy wires, and wherein heating or cooling of the shape memory alloy wires is to cause the portion of the first housing to move between the first placement and the second placement.

Example 70 includes the subject matter of any of Examples 55-69, and wherein the actuator comprises a stepper motor.

Example 71 includes the subject matter of any one of Examples 67-70, wherein the first air mover further comprises a first cutwater to divide a flow of air within the first internal volume between the first exhaust and a region of the first internal volume between the first cutwater and the first impeller, wherein the first cutwater is movable, wherein a minimum distance between the first cutwater and the first impeller is a first distance when the first cutwater is in a first placement and a second distance when the first cutwater is in a second placement, wherein the first distance is greater than the second distance, wherein the first cutwater is positioned between the first exhaust and the second exhaust; wherein the second air mover comprises a second cutwater to divide the flow of air within the second internal volume between third second cutwater and a region of the second internal volume between the second cutwater and the second impeller, wherein the second cutwater is movable, wherein a minimum distance between the second cutwater and the second impeller is a third distance when the second cutwater is in a third placement and a fourth distance when the second cutwater is in a fourth placement, wherein the third distance is less than the fourth distance, and wherein the second cutwater positioned between the third exhaust and the fourth exhaust.

Example 72 includes the subject matter of any of Examples 55-71, and further including a first cutwater actuator to cause the first cutwater to move between the first placement and the second placement.

Example 73 includes the subject matter of any of Examples 55-72, and wherein the first cutwater actuator comprises a stepper motor to cause the first cutwater to move between the first placement and the second placement.

Example 74 includes the subject matter of any of Examples 55-73, and wherein the first cutwater actuator comprises one or more shape memory alloy wires, wherein heating or cooling of the shape memory alloy wires is to cause the first cutwater to move between to move between the first placement and the second placement.

Example 75 includes the subject matter of any of Examples 55-74, and further including a spring attached to the first cutwater, wherein a spring force of the spring is to hold the first cutwater in the first placement when the spring force is greater than aerodynamic forces pushing against the first cutwater, and wherein the first cutwater to move toward the second placement when the aerodynamic forces pushing against the first cutwater are greater than the spring force holding the first cutwater in the first placement.

Example 76 includes the subject matter of any one of Examples 71-75, wherein the first cutwater comprises a cam.

Example 77 includes the subject matter of any of Examples 55-76, and wherein the first air mover further comprises a first strip located in the first housing, wherein the first strip is movable, wherein the first strip in a first strip placement extends into the first exhaust and does not extend into the first exhaust when the first strip is in a second strip placement, wherein the second air mover further comprises a second strip located in the second air mover, wherein the second strip is movable, wherein the second strip in a third strip placement extends into the third exhaust and in a fourth strip placement extends into the fourth exhaust.

Example 78 includes the subject matter of any of Examples 55-77, and wherein a portion of the first strip is capable of moving along a surface of an interior surface of the first air mover.

Example 79 includes the subject matter of claim 77 or 78, wherein the first strip is flexible.

Example 80 includes the subject matter of any one of Examples 77-79, further comprising an actuator to cause the first strip to move between the first strip placement and the second strip placement.

Example 81 includes the subject matter of any one of Examples 77-80, further wherein the first strip comprises first teeth and the actuator comprises a gear comprising second teeth to engage with the first teeth.

Example 82 includes the subject matter of any one of Examples 77-81, wherein the first air mover comprises a first cutwater to divide the flow of air within the first internal volume between the first exhaust and a region of the first internal volume between the first cutwater and the first impeller, wherein the first cutwater is movable, wherein a minimum distance between the first cutwater and the first impeller is a first distance when the first cutwater is in a first cutwater placement and a second distance when the first cutwater is in a second cutwater placement, wherein the first distance is greater than the second distance, wherein the first cutwater is positioned between the first exhaust and the second exhaust, wherein the second air mover comprises a second cutwater to divide the flow of air within the second internal volume between the third exhaust and the fourth exhaust, wherein a minimum distance between the second cutwater and the second impeller is a third minimum distance when the second cutwater is in a third placement and a fourth minimum distance when the second cutwater is in a fourth placement, wherein the third minimum distance is less than the fourth minimum distance, and wherein the second cutwater is positioned between the third exhaust and the fourth exhaust.

Example 83 includes the subject matter of any of Examples 55-82, and further including a stepper motor to cause the first cutwater to move between the first cutwater placement and the second cutwater placement.

Example 84 includes the subject matter of any of Examples 55-83, and further including an actuator comprising one or more shape memory alloy wires, wherein heating or cooling of the shape memory alloy wires is to cause the first cutwater to move between the first cutwater placement and the second cutwater placement.

Example 85 includes the subject matter of any one of Examples 77-84, further comprising a spring attached to the first cutwater, wherein a spring force of the spring is to hold the first cutwater in the first cutwater placement when the spring force is greater than aerodynamic forces pushing against the first cutwater, and wherein the first cutwater is to move toward the second cutwater placement when the aerodynamic forces pushing against the first cutwater are greater than the spring force holding the first cutwater in the first cutwater placement.

Example 86 includes the subject matter of any one of Examples 82-85, wherein the first cutwater comprises a cam.

Example 87 includes the subject matter of any one of Examples 55-86, wherein the first air mover further comprises a fifth exhaust and the second air mover comprises a sixth exhaust, wherein the system further comprises a first memory integrated circuit component positioned adjacent to the first exhaust and a second integrated circuit component positioned adjacent to the sixth exhaust.

Example 88 includes the subject matter of any of Examples 55-87, and wherein the first air mover comprises a first exhaust cover capable of moving between a first exhaust cover position in which the first exhaust cover covers the fifth exhaust and one or more second exhaust cover positions in which the first exhaust cover leaves at least a portion of the fifth exhaust uncovered, and the second air mover comprises a second exhaust cover capable of moving between a third exhaust cover position in which the second exhaust cover covers the sixth exhaust and one or more sixth exhaust cover positions in which the second exhaust cover leaves at least a portion of the sixth exhaust uncovered.

Example 89 includes the subject matter of any one of Examples 55-88, further comprising a system exhaust positioned adjacent to the core region of the printed circuit board.

Example 90 includes the subject matter of any of Examples 55-89, and wherein the system exhaust is a center system exhaust, the system further comprising a left system exhaust positioned adjacent to the first heat exchanger and a right system exhaust positioned adjacent to the second heat exchanger, the center system exhaust positioned between the left system exhaust and the right system exhaust.

Example 91 includes the subject matter of any one of Examples 55-90, wherein the heat transfer device is a vapor chamber.

Example 92 includes a method comprising receiving telemetry information; determining a physical modification to be made to an air mover located in a computing system based on the telemetry information and/or information derived from the telemetry information; and sending information to the air mover to cause the physical modification to the air mover.

Example 93 includes the subject matter of Example 92, and wherein the telemetry information comprises telemetry information provided by one or more integrated circuit components of the computing system.

Example 94 includes the subject matter of any of Examples 92 and 93, and wherein the telemetry information comprises information indicating a temperature.

Example 95 includes the subject matter of any of Examples 92-94, and wherein the temperature is of an integrated circuit component of the computing system.

Example 96 includes the subject matter of any of Examples 92-95, and wherein the temperature is a skin temperature of the computing system.

Example 97 includes the subject matter of any one of Examples 94-96, wherein to determine the physical modification to be made to the air mover located in the computing system based on the telemetry information and/or information derived from the telemetry information comprises determining that the temperature exceeds a temperature threshold.

Example 98 includes the subject matter of any one of Examples 94-96, wherein to determine the physical modification to be made to the air mover located in the computing system based on the telemetry information and/or information derived from the telemetry information comprises determining from information derived from the telemetry information that a rate of change of the temperature exceeds a rate of temperature change threshold.

Example 99 includes the subject matter of any of Examples 92-98, and wherein the telemetry information comprises information indicating a power consumption level.

Example 100 includes the subject matter of any of Examples 92-99, and wherein the telemetry information comprises information indicating a power consumption level of an integrated circuit component of the computing system.

Example 101 includes the subject matter of any of Examples 92-100, and wherein the telemetry information comprises information indicating a power consumption level of the computing system.

Example 102 includes the subject matter of any one of Examples 99-101, wherein to determine the physical modification to be made to the air mover located in the computing system based on the telemetry information and/or information derived from the telemetry information comprises determining that the power consumption level exceeds a power consumption threshold.

Example 103 includes the subject matter of any one of Examples 99-101, wherein to determine the physical modification to be made to the air mover located in the computing system based on the telemetry information and/or information derived from the telemetry information comprising determining from information derived from the telemetry information that a rate of change of the power consumption level exceeds a rate of power consumption change threshold.

Example 104 includes the subject matter of any one of Examples 97, 98, 102, or 103, wherein the air mover comprises a cutwater and an impeller and the physical modification comprises moving the cutwater from a first placement to a second placement, and wherein a minimum distance between the cutwater and the impeller when the cutwater is in the first placement is greater than a minimum distance between the cutwater and the impeller when the cutwater is in the second placement.

Example 105 includes the subject matter of any of Examples 92-104, and wherein the cutwater is a first cutwater and the air mover further comprises a second cutwater, wherein the physical modification further comprises moving the second cutwater from a third placement to a fourth placement, and wherein a minimum distance between the second cutwater and the impeller when the second cutwater is in the third placement is greater than a minimum distance between the second cutwater and the impeller when the second cutwater is in the fourth placement.

Example 106 includes the subject matter of any one of Examples 97, 98, 102, or 103, wherein the air mover comprises an exhaust and a strip, and wherein the physical modification comprises moving the strip to extend into the exhaust.

Example 107 includes the subject matter of any of Examples 92-106, and wherein the exhaust is a first exhaust, the air mover further comprising a second exhaust, and wherein the physical modification comprises moving the strip to extend into the second exhaust.

Example 108 includes the subject matter of any one of Examples 97, 98, 102, or 103, wherein the air mover comprises an expandable portion of an air mover housing, and wherein the physical modification comprises expanding the expandable portion of the air mover housing.

Example 109 includes the subject matter of any of Examples 92-108, and wherein the telemetry information comprises information indicating a temperature of a memory integrated circuit component.

Example 110 includes the subject matter of any of Examples 92-109, and wherein to determine the physical modification to be made to the air mover located in the computing system based on the telemetry information and/or information derived from the telemetry information comprises determining that the temperature of the memory integrated circuit component exceeds a temperature threshold.

Example 111 includes the subject matter of any of Examples 92-110, and wherein to determine the physical modification to be made to the air mover located in the computing system based on the telemetry information and/or information derived from the telemetry information comprising determining from information derived from the telemetry information that a rate of change of the temperature of the memory integrated circuit component exceeds a rate of temperature change threshold.

Example 112 includes the subject matter of any of Examples 92-111, and wherein the telemetry information comprises information indicating a power consumption level of a memory integrated circuit component of the computing system.

Example 113 includes the subject matter of any of Examples 92-112, and wherein to determine the physical modification to be made to the air mover located in the computing system based on the telemetry information and/or information derived from the telemetry information comprises determining that the power consumption level of the memory integrated circuit component exceeds a power consumption threshold.

Example 114 includes the subject matter of any of Examples 92-113, and wherein to determine the physical modification to be made to the air mover located in the computing system based on the telemetry information and/or information derived from the telemetry information comprising determining from information derived from the telemetry information that a rate of change of the power consumption level of the memory integrated circuit component exceeds a rate of power consumption change threshold.

Example 115 includes the subject matter of any one of Examples 110, 111, 113, or 114, wherein the air mover comprises an exhaust and an exhaust cover, and wherein the physical modification comprises moving the exhaust cover to uncover the exhaust.

Example 116 includes the subject matter of any one of Examples 110, 111, 113, or 114, wherein the air mover comprises an exhaust and an exhaust cover, and wherein the physical modification comprises moving the exhaust cover to further uncover the exhaust.

Example 117 includes the subject matter of any one of Examples 110, 111, 113, or 114, wherein the air mover comprises an exhaust comprising a plurality of slots and a strip comprising a plurality of slots, and wherein the physical modification comprises moving the strip to align the slots of the strip with the slots of the exhaust.

Example 118 includes the subject matter of any one of Examples 94-96, wherein to determine the physical modification to be made to the air mover located in the computing system based on the telemetry information and/or information derived from the telemetry information comprises determining that the temperature is less than a temperature threshold.

Example 119 includes the subject matter of any one of Examples 94-96, wherein to determine the physical modification to be made to the air mover located in the computing system based on the telemetry information and/or information derived from the telemetry information comprising determining from information derived from the telemetry information that a rate of change of the temperature is less than a rate of temperature change threshold.

Example 120 includes the subject matter of any one of Examples 99-101, wherein to determine the physical modification to be made to the air mover located in the computing system based on the telemetry information and/or information derived from the telemetry information comprises determining that the power consumption level is less than a power consumption threshold.

Example 121 includes the subject matter of any one of Examples 99-101, wherein to determine the physical modification to be made to the air mover located in the computing system based on the telemetry information and/or information derived from the telemetry information comprising determining from information derived from the telemetry information that a rate of change of the power consumption level is less than a rate of power consumption change threshold.

Example 122 includes the subject matter of any one of Examples 118-121, wherein the air mover comprises a cutwater and an impeller and the physical modification comprises moving the cutwater from a first placement to a second placement, and wherein a minimum distance between the cutwater and the impeller when the cutwater is in the first placement is less than a minimum distance between the cutwater and the impeller when the cutwater is in the second placement.

Example 123 includes the subject matter of any of Examples 92-122, and wherein the cutwater is a first cutwater, the air mover further comprises a second cutwater, the physical modification further comprising moving the second cutwater from a third placement to a fourth placement, and wherein a minimum distance between the second cutwater and the impeller when the second cutwater is in the third placement is less than a minimum distance between the second cutwater and the impeller when the second cutwater is in the fourth placement.

Example 124 includes the subject matter of any one of Examples 118-121, wherein the air mover comprises an exhaust and a movable strip, the physical modification comprising moving the movable strip to extend into the exhaust.

Example 125 includes the subject matter of any one of Examples 124, wherein the exhaust is a first exhaust, the air mover further comprising a second exhaust, the physical modification comprising moving the movable strip to extend into the second exhaust.

Example 126 includes the subject matter of any one of Examples 118-121, wherein the air mover comprises an expandable portion of an air mover housing, and wherein the physical modification comprising contracting the expandable portion of the air mover housing.

Example 127 includes the subject matter of any of Examples 92-126, and wherein to determine the physical modification to be made to the air mover located in the computing system based on the telemetry information and/or information derived from the telemetry information comprises determining that the temperature of the memory integrated circuit component is less than a temperature threshold.

Example 128 includes the subject matter of any of Examples 92-127, and wherein to determine the physical modification to be made to the air mover located in the computing system based on the telemetry information and/or information derived from the telemetry information comprising determining from information derived from the telemetry information that a rate of change of the temperature of the memory integrated circuit component is less than a rate of temperature change threshold.

Example 129 includes the subject matter of any of Examples 92-128, and wherein to determine the physical modification to be made to the air mover located in the computing system based on the telemetry information and/or information derived from the telemetry information comprises determining that the power consumption level of the memory integrated circuit component is less than a power consumption threshold.

Example 130 includes the subject matter of any of Examples 92-129, and wherein to determine the physical modification to be made to the air mover located in the computing system based on the telemetry information and/or information derived from the telemetry information comprising determining from information derived from the telemetry information that a rate of change of the power consumption level of the memory integrated circuit component is less than a rate of power consumption change threshold.

Example 131 includes the subject matter of any one of Examples 127-130, wherein the air mover comprises an exhaust and an exhaust cover, the physical modification comprising moving the exhaust cover to cover the exhaust.

Example 132 includes the subject matter of any one of Examples 127-130, wherein the air mover comprises an exhaust and an exhaust cover, the physical modification comprising moving the exhaust cover to further cover the exhaust.

Example 133 includes the subject matter of any one of Examples 127-130, wherein the air mover comprises an exhaust comprising a plurality of slots and a strip comprising a plurality of slots, and wherein the physical modification comprising moving the strip so that slots of the strip are not aligned with the slots of the exhaust.

Example 134 includes one or more computer-readable storage media storing computer-executable instructions that, when executed, cause one or more processor units of a computing device to perform the method of any one of Examples 92-133.

Example 135 includes an apparatus comprising one or more means to perform the method of any one of Examples 92-133.

Example 136 includes an apparatus comprising an impeller; a housing defining an internal volume and an exhaust, wherein the impeller is located within the internal volume; and an air flow adjustment means to adjust an amount of air flow through the exhaust.

Example 137 includes the subject matter of Example 136, and wherein the exhaust is a first exhaust and the air flow adjustment means is a first air flow adjustment means to adjust the amount of air flow through the first exhaust, and wherein the apparatus further comprising a second exhaust and an air flow split adjustment means to adjust an air flow split between the first exhaust and the second exhaust.

Example 138 includes the subject matter of any of Examples 136 and 137, and further including a printed circuit board; one or more processing units attached to the printed circuit board; a heat transfer device located on the one or more processing units; and a heat exchanger attached to the heat transfer device, wherein the heat exchanger is positioned to direct air flowing out of the exhaust over or through the heat exchanger.

Example 139 includes the subject matter of any of Examples 136-138, and wherein the heat transfer device is a vapor chamber.

1. An apparatus, comprising:
an impeller capable of rotating;
a housing defining an internal volume and an exhaust, the impeller located within the internal volume; and
a cutwater to divide a flow of air within the internal volume between the exhaust and a region of the internal volume between the cutwater and the impeller, wherein the cutwater is capable of moving, wherein a minimum distance between the cutwater and the impeller is a first distance when the cutwater is in a first cutwater placement and a second distance when the cutwater is in a second cutwater placement, and wherein the first distance is greater than the second distance.

2. The apparatus of claim 1 further comprising an actuator comprising one or more shape memory alloy wires, wherein heating or cooling of the shape memory alloy wires causes the cutwater to move between the first cutwater placement and the second cutwater placement.

3. The apparatus of claim 1, further comprising a spring attached to the cutwater, wherein a spring force of the spring is to hold the cutwater in the first cutwater placement when the spring force is greater than aerodynamic forces pushing against the cutwater, and wherein the cutwater is to move toward the second cutwater placement when the aerodynamic forces pushing against the cutwater are greater than the spring force holding the cutwater in the first cutwater placement.

4. The apparatus of claim 1, wherein the cutwater comprises a cam.

5. The apparatus of claim 1, wherein the exhaust is a first exhaust, and wherein the apparatus further comprising a second exhaust, an exhaust cover capable of moving between a first exhaust cover position in which the exhaust cover covers the second exhaust and one or more second exhaust cover positions in which the exhaust cover leaves at least a portion of the second exhaust uncovered.

6. The apparatus of claim 1, wherein the exhaust is a first exhaust, the apparatus further comprising a second exhaust, wherein the cutwater is located between the first exhaust and the second exhaust.

7. The apparatus of claim 6, wherein the cutwater is a first cutwater, the apparatus further comprising a second cutwater, wherein the second exhaust is located between the first cutwater and the second cutwater, wherein the second cutwater is to divide the flow of air within the internal volume between the second exhaust and a region of the internal volume between the second cutwater and the impeller, wherein the second cutwater is capable of moving, wherein a minimum distance between the second cutwater and the impeller is a third distance when the second cutwater is in a third placement and a fourth distance when the second cutwater is in a fourth placement, and wherein the third distance is greater than the fourth distance.

8. The apparatus of claim 6, the apparatus further comprising a third exhaust, an exhaust cover capable of moving between a first exhaust cover position in which the exhaust cover covers the third exhaust and one or more second exhaust cover positions in which the exhaust cover leaves at least a portion of the third exhaust uncovered.

9. An apparatus, comprising:
an impeller; and
a housing defining an internal volume and an exhaust, the impeller located within the internal volume, wherein a portion of the housing is capable of moving from a first housing portion placement in which the internal volume is a first volume to a second housing portion placement in which the internal volume is a second volume, the second volume greater than the first volume.

10. The apparatus of claim 9, further comprising a cutwater to divide a flow of air within the internal volume between the exhaust and a region of the internal volume between the cutwater and the impeller, wherein the cutwater is capable of moving, wherein a minimum distance between the cutwater and the impeller is a first distance when the cutwater is in a first cutwater placement and a second distance when the cutwater is in a second cutwater placement, and wherein the first distance is greater than the second distance.

11. The apparatus of claim 10, wherein the exhaust is a first exhaust and the cutwater is a first cutwater, the apparatus further comprising a second exhaust and a second cutwater, wherein the first cutwater is located between the first exhaust and the second exhaust, wherein the second exhaust is located between the first cutwater and the second cutwater, wherein the second cutwater is to divide the flow of air within the internal volume between the second exhaust and a region of the internal volume between the second cutwater and the impeller, wherein the second cutwater is capable of moving, wherein a minimum distance between the second cutwater and the impeller is a third distance when the second cutwater is in a third placement and a fourth distance when the second cutwater is in a fourth placement, and wherein the third distance is greater than the fourth distance.

12. An apparatus comprising:
an impeller;
a housing, defining an internal volume, a first exhaust, and a second exhaust, the impeller located within the internal volume; and
a strip located within the internal volume of the housing, wherein the strip is capable of moving, and wherein the strip extends into the first exhaust in a first strip placement and extends into the second exhaust in a second strip placement.

13. The apparatus of claim 12, further comprising a cutwater to divide a flow of air within the internal volume between the first exhaust and the second exhaust, wherein the cutwater is capable of moving, wherein a minimum distance between the cutwater and the impeller is a first distance when the cutwater is in a first cutwater placement and a second distance when the cutwater is in a second cutwater placement, wherein the first distance is greater than the second distance, and wherein the cutwater is positioned between the first exhaust and the second exhaust.

14. The apparatus of claim 12, further comprising a third exhaust comprising a plurality of slots, wherein the strip comprises a plurality of slots, and wherein the strip is further capable of moving to a third placement in which the slots of the strip align with the slots of the third exhaust.

15. The apparatus of claim 1, wherein the housing is an air mover housing, the apparatus further comprising:
a printed circuit board;
one or more processing units attached to the printed circuit board;
a heat transfer device located on the one or more processing units; and
a system housing enclosing the processing units, the heat transfer device, the air mover housing and the printed circuit board.

16. A system comprising:
a first air mover comprising a first exhaust and a second exhaust;
a second air mover comprising a third exhaust and a fourth exhaust;
a printed circuit board comprising a core region positioned between the first air mover and the second air mover, wherein the first air mover and the second air mover are positioned such that the second exhaust and the fourth exhaust direct air existing the second exhaust and the fourth exhaust toward the core region;
one or more processor units attached to the core region of the printed circuit board;
a heat transfer device located on the one or more processor units;
a first heat exchanger attached to the heat transfer device and positioned adjacent to the first exhaust; and
a second heat exchanger attached to the heat transfer device and positioned adjacent to the third exhaust.

17. The system of claim 16, wherein:
the first air mover comprises:
a first impeller;
a first housing defining a first internal volume, the first exhaust, and the second exhaust, wherein the first impeller is located within the first internal volume; and
a first cutwater to divide a flow of air within the first internal volume between the first exhaust and a region of the first internal volume between the first cutwater and the first impeller, wherein the first cutwater is capable of moving, wherein a minimum distance between the first cutwater and the first impeller is a first distance when the first cutwater is in a first cutwater placement and a second distance when the first cutwater is in a second cutwater placement, wherein the first distance is greater than the second distance, and wherein the first cutwater is positioned between the first exhaust and the second exhaust; and
the second air mover comprises:
a second impeller;
a second housing defining a second internal volume, the third exhaust, and the fourth exhaust, wherein the second impeller is located within the second internal volume; and
a second cutwater to divide the flow of air within the second internal volume between the third exhaust and a region of the second internal volume between the second cutwater and the second impeller, wherein the second cutwater is capable of moving, wherein a minimum distance between the second cutwater and the second impeller is a third distance when the second cutwater is in a second cutwater placement and a fourth distance when the second cutwater is in a fourth cutwater placement, wherein the third distance is greater than the fourth distance, and wherein the second cutwater is positioned between the third exhaust and the fourth exhaust.

18. The system of claim 17, wherein the first air mover further comprises a third cutwater to divide the flow of air within the first internal volume between the first exhaust and the region of the first internal volume between the third cutwater and the first impeller, wherein the third cutwater is capable of moving, wherein a minimum distance between the third cutwater and the first impeller is a fifth distance when the third cutwater is in a fifth placement and a sixth distance when the third cutwater is in a sixth placement, wherein the fifth distance is greater than the sixth distance, wherein the third cutwater is positioned between the first exhaust and the second exhaust; wherein the second air mover comprises a fourth cutwater to divide the flow of air within the second internal volume between the third exhaust and a region of the second internal volume between the fourth cutwater and the second impeller, wherein the fourth cutwater is capable of moving, wherein a minimum distance between the fourth cutwater and the second impeller is a seventh distance when the fourth cutwater is in a seventh placement and an eighth distance when the fourth cutwater is in an eighth placement, wherein the seventh distance is greater than the eighth distance, and wherein the fourth cutwater is positioned between the third exhaust and the fourth exhaust.

19. The system of claim 16, wherein:
the first air mover comprises:
a first impeller;
a first housing defining a first internal volume, the first exhaust, and the second exhaust, wherein the first impeller is located within the first internal volume; and
a portion of the first housing located adjacent to the first exhaust that is capable of expanding from a first placement in which the first exhaust has a first exhaust size to a second placement in which the first exhaust has a second exhaust size, and wherein the second exhaust size is greater than the first exhaust size; and
the second air mover comprises:
a second impeller;
a second housing defining a second internal volume, the third exhaust, and the fourth exhaust, wherein the second impeller is located within the second internal volume; and
a portion of the second housing located adjacent to the third exhaust that is capable of expanding from a third position in which the third exhaust has a third exhaust size to a fourth placement in which the fourth exhaust has a fourth exhaust size, and wherein the fourth exhaust size is greater than the third exhaust size.

20. The system of claim 19, wherein the first air mover further comprises a first cutwater to divide a flow of air within the first internal volume between the first exhaust and a region of the first internal volume between the first cutwater and the first impeller, wherein the first cutwater is capable of moving, wherein a minimum distance between the first cutwater and the first impeller is a first distance when the first cutwater is in a first placement and a second distance when the first cutwater is in a second placement, wherein the first distance is greater than the second distance, wherein the first cutwater is positioned between the first exhaust and the second exhaust; wherein the second air mover comprises a second cutwater to divide the flow of air within the second internal volume between third second cutwater and a region of the second internal volume between the second cutwater and the second impeller, wherein the second cutwater is capable of moving, wherein a minimum distance between the second cutwater and the second impeller is a third distance when the second cutwater is in a third placement and a fourth distance when the second cutwater is in a fourth placement, wherein the third distance is less than the fourth distance, and the second cutwater is positioned between the third exhaust and the fourth exhaust.

21. The system of claim 17, wherein the first air mover further comprises a first strip located in the first housing, wherein the first strip is capable of moving, wherein the first strip extends into the first exhaust in a first strip placement and does not extend into the first exhaust in a second strip placement, wherein the second air mover further comprises a second strip located in the second air mover, wherein the second strip is capable of moving, wherein the second strip extends into the third exhaust in a third strip placement and does not extend into the fourth exhaust in a fourth strip placement.

22. The system of claim 21, wherein the first air mover comprises a first cutwater to divide the flow of air within the first internal volume between the first exhaust and a region of the first internal volume between the first cutwater and the first impeller, wherein the first cutwater is capable of moving, wherein a minimum distance between the first cutwater and the first impeller is a first distance when the first cutwater is in a first cutwater placement and a second distance when the first cutwater is in a second cutwater placement, wherein the first distance is greater than the second distance, wherein the first cutwater is positioned between the first exhaust and the second exhaust, wherein the second air mover comprises a second cutwater to divide the flow of air within the second internal volume between the third exhaust and the fourth exhaust, wherein a minimum distance between the second cutwater and the second impeller is a third minimum distance when the second cutwater is in a third placement and a fourth minimum distance when the second cutwater is in a fourth placement, wherein the third minimum distance is less than the fourth minimum distance, and wherein the second cutwater is positioned between the third exhaust and the fourth exhaust.

23. The system of claim 16, wherein the first air mover further comprises a fifth exhaust and the second air mover comprises a sixth exhaust, wherein the system further comprises a first memory integrated circuit component positioned adjacent to the first exhaust and a second integrated circuit component positioned adjacent to the sixth exhaust.

24. The system of claim 23, wherein the first air mover comprises a first exhaust cover capable of moving between a first exhaust cover position in which the first exhaust cover covers the fifth exhaust and one or more second exhaust cover positions in which the first exhaust cover leaves at least a portion of the fifth exhaust uncovered, and wherein the second air mover comprises a second exhaust cover capable of moving between a third exhaust cover position in which the second exhaust cover covers the sixth exhaust and one or more sixth exhaust cover positions in which the second exhaust cover leaves at least a portion of the sixth exhaust uncovered.

25. The system of claim 16, the system further comprising a center system exhaust positioned adjacent to the core region of the printed circuit board, a left system exhaust positioned adjacent to the first heat exchanger, and a right system exhaust positioned adjacent to the second heat exchanger, the center system exhaust positioned between the left system exhaust and the right system exhaust.
